(19) United States
(12) Patent Application Publication
(10) Pub. No.: US 2012/0148252 A1
(43) Pub. Date: Jun. 14, 2012

(54) ENCODING AN OPTICAL SIGNAL USING A RADIO-FREQUENCY SIGNAL

(75) Inventor: Dmitry Turchinovich, Copenhagen Ø (DK)

(73) Assignee: DANMARKS TEKNISKE UNIVERSITET, Lyngby (DK)

(21) Appl. No.: 13/388,936

(22) PCT Filed: Jul. 29, 2010
(86) PCT No.: PCT/DK10/50200

§ 371 Date: Feb. 28, 2012

(30) Foreign Application Priority Data
Aug. 6, 2009 (EP) 09167373.1

(51) Int. Cl. H04B 10/10

(52) U.S. Cl. 398/116

(57) ABSTRACT

The present invention provides a method for modulating an optical signal in a semiconductor device. A wireless radio frequency modulation signal is used to provide a time-dependent electric field in a semiconductor nanostructure region, which causes a change in the absorption in the semiconductor device. An optical signal propagating in the semiconductor device will be modulated in accordance with the properties of the wireless radio frequency modulation signal, thus providing a method for encoding information from a wireless radio frequency signal onto an optical carrier.

### FIELD OF THE INVENTION

The present invention relates to using a wireless radio frequency (RF) signal, such as a GHz or THz frequency signal, to provide an optical signal carrying substantially the same information as the wireless RF signal. Information carried by the RF signal can be imparted on the optical signal using a method and device in accordance with the present invention.

### BACKGROUND OF THE INVENTION

Current communication systems technology allows for transfer rates up to about 1 Terabit/second (Tbit/s). Such systems are based on optical signals. A multitude of Gigabit/s (Gbit/s) emitters are combined to produce this high a transfer rate, via optical time-division multiplexing (OTDM). An obstacle on the path to higher transfer rates using single emitter are fundamental: direct THz-rate modulation of currents in for instance semiconductor laser diodes, or control voltages in phase-shift-based switches does not produce satisfactory effects due to intrinsically “large” RC time constants (resistance times capacitance) in such devices—“large” in the sense that the associated charge/discharge rate limits the modulation speed to perhaps 10 GHz to 40 GHz, orders of magnitude lower than 1 THz. Ultrafast optically induced switching of laser diodes is possible; however, the

THz modulation rates is ultimately difficult to achieve due to a slow recovery of the cold electron population. This process is too slow to provide modulation rates higher than about 100 GHz.

Although optical time-division multiplexing can combine multiple emitters each having “low” repetition rates (such as 10 Gbit/s) to achieve high transfer rates at optical wavelengths, no digital encoding of a THz signal onto an optical signal is currently possible.

EP 1 416 316 and GB 2 386 965 disclose interferometers for modulating an optical signal, using electrically responsive optical phase shifters or modulators in the respective branches. The phase shifters involve a quantum dot containing layer. The modulation signals are RF hard wired voltage signals received over an electrical wire and applied over the phase shifter by electrodes or metal contact layers deposited thereon.

It is a disadvantage that the driving circuit for supplying the hard wire signal to the phase shifters leads to an RC-constant that limits the modulation speed of the phase shifter to appr. 100 GHz.

### SUMMARY OF THE INVENTION

It is an object of the invention to provide a method and a device for coherent detection and/or instantaneous encoding of wireless high-frequency radio frequency (RF) signals with frequencies reaching hundreds of GHz to THz onto an optical carrier signal.

It is another object of the invention to provide a method and a device for modulating optical signals, where obtainable speeds are not limited by RC time constants in electrical circuitry.

It is yet another object of the invention to provide a method and a device for (direct) encoding of wireless high-frequency RF signals onto an optical signal. This enables coherent detection of the wireless RF signal via encoding of it onto an optical signal that can then be detected in known ways.

The invention thereby provides solutions to problems of the prior art corresponding to these objects.

In a first aspect, the present invention provides a method for modulating an optical input signal having a first frequency, comprising:
coupling the optical input signal into a semiconductor nanostructure region in a semiconductor structure through a first optical interface, the semiconductor structure comprising:
   the semiconductor nanostructure region, the semiconductor nanostructure region comprising a plurality of semiconductor nanostructure elements, the semiconductor nanostructure region being capable of absorbing a portion of the optical input signal coupled into the semiconductor nanostructure region;
   the first optical interface;
   a second optical interface through which a non-absorbed portion of the optical input signal can be coupled out of the semiconductor nanostructure region in the form of a modulated optical output signal; and
   a radio frequency receiver element facilitating a low-loss coupling of a wireless modulation radio frequency signal having a second frequency into the semiconductor nanostructure region;
providing the wireless modulation radio frequency signal to the radio frequency receiver element and coupling the wireless modulation radio frequency signal into the semiconductor nanostructure region in temporal overlap with the optical input signal to provide a time-dependent electric field across the semiconductor nanostructure region resulting, by means of the quantum-confined Stark effect (QCSE), in a change in an absorption and possibly also phase (due to the electrorefractive effect) at the first frequency of the optical input signal in the semiconductor nanostructure region; and
coupling a non-absorbed portion of the optical input signal through the second optical interface, thereby providing said modulated optical output signal.

The change in absorption and possibly phase at the first frequency caused by the RF signal can be used to modulate data from the RF signal onto the optical input signal, or be used to detect characteristics of the RF signal by transfer of these onto the optical input signal followed by detection of the optical output signal.

In a second aspect of the invention, a signal modulator or RF-to-optical encoder device is provided. The signal modulator can provide an optical output signal based on a wireless radio frequency modulation signal and an optical input signal, the optical output signal having a first frequency and the radio frequency modulation signal having a second frequency. The signal modulator comprises a semiconductor structure comprising:
a semiconductor nanostructure region comprising a plurality of semiconductor nanostructure elements, the semiconductor nanostructure region being capable of absorbing a portion of the input signal;
a first optical interface through which the optical input signal can be coupled into the semiconductor nanostructure region;
a second optical interface through which a non-absorbed portion of the optical input signal can be coupled out of the semiconductor nanostructure region to form the optical output signal; and
a radio frequency receiver element facilitating a low-loss coupling of a wireless modulation radio frequency signal having a second frequency into the semiconductor nanostructure region.

In the following, a number of preferred and/or optional features, elements, examples, implementations and advantages will be summarized. Features or elements described in relation to one embodiment or aspect may be combined with or applied to the other embodiments or aspects where applicable. For example, structural and functional features applied in relation to a method implementation may also be used as features in relation to the device and vice versa. Also, explanations of underlying mechanisms of the invention as realized by the inventors are presented for explanatory purposes, and should not be used in ex post facto analysis for deducing the invention.

Application of an electric field to a quantum-confined system, such as for example quantum well, quantum wire, quantum dot, etc, along the the direction of the quantum confinement will lead to an effect known as quantum-confined Stark effect (QCSE). As a result of application of an eledtric field, F, the confinement potential for charged carriers—the electrons and the holes, is modified in a way that the optical transition energy decreases as a result of the band structure tilt, and the probability of the optical transition decreases as a result of larger spatial separation between the electron and hole wavefunctons. The probability of the optical transition is roughly proportional to the optical absorption coefficient.

According to the working principle of the present invention, the application of electric field to the semiconductor nanostructure region along the direction of quantum confinement will result, in particular, in the reduction of optical absorption coefficient of the nanostructure at the wavelength of the optical input signal.

Now, if the electric field is applied not in a static, but rather in a time-varying manner, then the corresponding modification of the confinement potential of the semiconductor nanostructure will instantaneously follow the time-varying electric field. Thus, for example, an optical absorption coefficient will be time-varying, as it will follow the modification of the confinement potential, as influenced by a time varying electric field.

According to the invention, the time-varying electric field will be supplied to the structure comprising the semiconductor nanostructure by a wireless radio frequency signal, thus leading the modification of, in particular, the optical absorption coefficient of the semiconductor nanostructure region with the rate corresponding to the change of electric field in the incident RF signal. We will thus employ the instantaneous nature of the QCSE induced by the RF wireless signal to provide the modulation of the optical input signal that will be transmitted through, or reflected from, the semiconductor nanostructure region.

By this method, information carried by the RF signal is imparted on the optical input signal. The effects by which the modulation on the RF signal is imparted on the optical signal are almost instantaneous, and modulation changes on a subpicosecond timescale, as well as on longer timescales, can therefore be imparted on the optical input signal. In an alternative formulation, the effects of the QCSE can be formulated as when the modulation RF signal is provided to the radio frequency receiver element, it again provides a time-dependent electric field across the first semiconductor nanostructure element, which causes a change in a valence band state of the first semiconductor nanostructure element from a first valence band state (Eₕ,ψₕ), to a second valence band state (E′ₕ,ψₕ^{′}) and a change in a conduction band state of the first semiconductor nanostructure element from a first conduction band state (Eₑ,ψₑ) to a second conduction band state (E′ₑ,ψₑ^{′}), whereby a wavefunction overlap in the semiconductor nanostructure element changes from <ψₕ|ψₑ >to <ψₕ^{′}|ψₑ^{′}>, which results in a change in an absorption at the first frequency of the optical input signal in the semiconductor nanostructure region. Thus, it follows that for the absorption experienced by the optical input signal to change, the first frequency should correspond to a photon energy sufficient for exciting a charge carrier from the first valence band state to the first conduction band state or from the second valence band state to the second conduction band state.

The method and the modulator can therefore be used for providing an optical data signal having the same information as an incident RF signal, which is very advantageous in optical communications systems, where this provides a way for receiving a wireless radio frequency signal by converting it into a corresponding optical signal.

The invention provides the advantage of modulating the optical input signal directly by the incident, wireless RF signal without a recourse to an intermediate electrical circuit. Thereby, the modulation is instantaneous and can support much higher modulation rates.

The method and the modulator allows for encoding a wireless radio frequency signal onto an optical signal, independent of the polarization states of both wireless and optical signals, as well as independent of the mutual orientations of the polarizations of a wireless radio frequency signal, optical signal, and orientation of the semiconductor nanostructure element. Some, rather weak, polarization dependency in respect to the mutual orientation of polarization of the optical signal and the orientation of the semiconductor nanostructure element may be expected as a result of anisotropy of optical absorption of the semiconductor nanostructure, however this will not lead to complete absence of the effect of the instantaneous modulation of the optical signal. Also, some rather weak dependency of the effect of the instantaneous modulation may arise from spatial anisotropy of semiconductor nanostructure, which will again not lead to the complete absence of the modulation effect. We note here, that this polarization independence of the modulation method is advantageous compared to other methods, such as photoconductive detection and free-space electrooptic sampling. There, it is always possible to find a mutual orientation of the polarizations of RF and optical signals, and the orientation of the RF receiver element, where RF signal detection, or encoding of the RF signal on the optical signal will be impossible.

Apart from use in communication systems, the same principle of RF-to-optical coherent encoding can very advantageously be used in high-frequency RF spectroscopy, sensing and imaging systems, where it can form part of a sensor, with the RF signal from the spectroscopy/sensing/imaging system (or other type of RF signal source) and the optical input signal as inputs. The optical output signal obtained by using the invention will comprise features from the RF signal and can then be analyzed in place of analyzing the RF signal itself. Various imaging, sensing and spectroscopy at THz frequency are discussed for instance in B. Ferguson and X.-C. Zhang, “Materials for terahertz science and technology”, Nature Materials, vol. 1, p. 26-33 (2002).

The invention produces an optical output signal that carries spectral features corresponding to those of the RF spectroscopy output signal. Detection of the optical output signal using suitable equipment is then used in order to reveal the spectroscopic information contained in the RF signal.

The semiconductor nanostructure is a core element of the invention. A semi-conductor nanostructure as used in the present invention is a semiconductor element that has at least one dimension which is smaller than 1 micrometer. Electrons and holes experience restricted motion along this dimension; they are quantum-confined. The optical properties associated with quantum-confined electrons and holes, such as optical transition energies and optical transition probabilities, are affected by the quantum confinement potential and the masses of the electrons and holes (often approximated using “effective masses”). In such a semiconductor nanostructure, an external electric field applied along this dimension of quantum confinement will essentially instantaneously lead to the modification of the optical transition parameters for electrons and holes, for instance the optical transition energies and optical transition probabilities. Thus the optical properties of the semiconductor structure, associated with the optical transitions, will change essentially instantaneously as a result of applied external electric field. If the external electric field is supplied by the electric field component of an incident wireless electromagnetic RF signal, then the optical properties of the semiconductor element will be modulated as a function of the electric field strength of the incident RF signal. If the optical input signal is transmitted through the semiconductor structure simultaneously with an incident RF signal, then the transmission of the optical input signal is modulated by the incident RF signal, resulting in the encoding of the information carried by the incident RF signal onto the optical input signal. This provides means of encoding an information from an RF signal having very high frequencies, such as GHz and THz, onto an optical signal.

The semiconductor nanostructures can comprise a “quantum well” (quantum confinement in one dimension), and/or a “quantum wire” (quantum confinement in two dimensions), and/or a “quantum dot” (quantum confinement in three dimensions). However, the semiconductor nanostructures can have other, more complex shapes. The essential principles of the invention will nevertheless be the same for any kind of semiconductor nanostructure used.

Below, the principles of the invention are discussed based on quantum dots as an example of semiconductor nanostructures.

The semiconductor structure can advantageously comprise a waveguide structure adapted to guide the optical input signal from the first waveguide interface to the second waveguide interface of the semiconductor structure, the waveguide structure and the semiconductor nanostructure region being optically coupled so that at least a part of the optical input signal, when guided in the waveguide structure, has an overlap with the semiconductor nanostructure region.

Advantageously, the modulation radio frequency signal is a signal comprising information to be encoded onto the optical input signal, such as an output from a radio frequency telecommunication or data transmission process, radio frequency spectroscopy process, radio frequency sensing process, or radio frequency imaging process. Other applications can be envisioned. The data modulated onto the RF signal, and thereby transferred to the optical signal, may be both analogue and/or digital. The frequency of the wireless RF signal, i.e. the second frequency, is preferably in the range 5 GHz to 50 THz, such as in the range 5 GHz to 20 THz. Frequencies at the higher end of this interval are not possible in electrical hard wired signals, and it is therefore evident to the skilled person that the RF signal is an electromagnetic radiation signal.

A quantum dot is a 3-dimensional piece of a narrow-bandgap semiconductor, surrounded by a wide-bandgap semiconductor, dielectric, or vacuum. The dimensions of a quantum dot usually do not exceed 100 nm. The quantum dots can be of different shapes: spherical, disc-like, lens-like, pyramid-like, cubic, etc. The schematic of a disc-like quantum dot is represented in FIG. 4, showing important dimensions in a disc-like quantum dot: radius (R), and height (d). Charge carriers in quantum dots are confined in three dimensions, and this can result in absence of or at least a very limited influence of effects related to heating of carriers and carrier escape from the quantum dot. The incident RF signal, which could for instance be an electric field with GHz or THz frequency, will induce an essentially instantaneous quantum-confined Stark effect (QCSE) in the quantum dot. The electric field of the RF signal induces a displacement of electron and hole wavefunctions, which will in turn cause a change (such as a reduction—this depends on the operating conditions) of the electron-hole wavefunction overlap (overlap integral). The transition probability for exciting an electron from the valence band to the conduction band (thereby creating an electron-hole pair), which affects the absorption probability (i.e. absorption strength) of the photon taking part in this optical transition, or affects the recombination efficiency of the created electron-hole pair, is proportional to the square of the overlap integral. In this way, it is not directly the supply of carriers that changes the absorption of the optical input signal, but rather the change in optical transition probability (i.e. absorption strength) contributed through the QCSE. Since the QCSE is (essentially) an instantaneous effect and is temporally coherent with the RF signal, the invention makes it possible to directly encode RF modulation onto an optical carrier at THz rate, therefore making it possible for instance to achieve a Tbit/s data rate in a telecommunication system.

We note here, that in some instances, a quantum well with a very short free-carrier lifetime and subject to the electric field of an incident RF signal, polarized parallel to the quantum well layers can be used instead of the quantum dot. The very short free carrier lifetime ca e.g. be provided by introducing of a number of trap states below the bangap. Such an arrangement can also result in the near-instantaneous modulation of the quantum well absorption by the electric field of an incident wireless RF signal by a Franz-Keldysh or bulk Stark effect. The absoprtion recovery speed will then depend on the efficient and fast enough capture of the electrons and/or holes photoexcited in the quantum well, onto the trap states.

By including a waveguiding structure (120) in the semiconductor structure, the modulation of the optical output signal can be increased because the overlap between the optical signal and the semiconductor nanostructure region is increased. The waveguide structure is adapted to at least partly guide the optical input signal from the first waveguide interface (121) to the second waveguide interface (122) of the semiconductor structure, and the waveguiding structure (120) and the semiconductor nanostructure region (112) are optically coupled so that at least a part of the optical input signal, when guided in the waveguiding structure (120), has an overlap with the semiconductor nanostructure region (112).

As described above, the invention has an advantage in that the modulation is not provided primarily through filling and emptying of quantum states, but through the change in wavefunction overlap that the RF signal causes.

The modulator according to the invention may be similar to a semiconductor optical amplifier or electro-absorption modulator, but adapted to provide the low-loss coupling of the RF modulation signal into the structure to have as much of the RF modulation signal enter the semiconductor nanostructure region. The reason is that in many applications and practical cases, the RF modulation signal is already quite weak. In some embodiments, the modulator in accordance with the second aspect of the invention can therefore be manufactured using the same equipment as that which is used for certain semiconductor optical amplifiers; the manufacturing just needs to be adapted so that a low-loss coupling of the radio frequency modulation signal into the semiconductor nanostructure region can be achieved.

The low-loss incoupling of an incident wireless modulating signal to the nanostructure region plays an important role in providing a high efficiency of inducing a quantum-confined Stark effect on the semiconductor nanostructures by an electric field of an incident wireless RF signal. The low-loss coupling is important to reduce or eliminate the reflection loss of the incident wireless RF signal at the surface of the RF-to-optical encoder device, preferably by providing an efficient impedance matching for the incident RF signal. The adaptation to low loss coupling of the RF modulation signal may be made in several different ways.

A relatively low-loss coupling can be obtained by providing only layers having a sufficiently low doping level (or doping levels) between the semiconductor nanostructure region and the radio frequency receiver element, that will reduce the absorption of the RF signal in the semiconductor structure by a free-carrier absorption effect, and by the increased interface reflectivity of the doped semiconductors, unless the doping level is chosen to provide the impedance matching for RF signal. Typically, the doping density should provide no more than about 10¹⁵ carriers per cm³. This number strongly depends on the types of materials used and the thickness of the layers. However, as will be described below, a certain, optimum doping level may lead to an enhancement of the RF signal incoupling at the surface of the structure. The person skilled in the art can design such layers appropriately given the teaching that the RF modulation signal should be coupled into the semiconductor nanostructure region with a low loss.

A low-loss coupling of the RF signal can be enhanced by providing an anti-reflection coating and/or impedance matching layer (or layers) at the radio frequency receiver element.

A generic configuration can be also used, where the angle of incidence of the wireless RF signal onto the device is the Brewster angle to the surface of the RF-to-optical encoder device, provided the polarization of the wireless RF signal is to a large degree linear.

As mentioned, the semiconductor structure can advantageously comprise a waveguide structure adapted to guide the optical input signal from the first waveguide interface to the second waveguide interface of the semiconductor structure, the waveguide structure and the semiconductor nanostructure region being optically coupled so that at least a part of the optical input signal, when guided in the waveguide structure, has an overlap with the semiconductor nanostructure region.

Advantageously, the optical input signal and the radio frequency modulation signal co-propagate. This increases the overlap and thus the modulation efficiency, i.e. the efficiency with which the information from the radio frequency modulation signal is imparted on the optical input signal.

Advantageously, when the optical input signal and the radio frequency modulation signal co-propagate in the semiconductor structure, their group velocities are identical or at least very similar in order to optimize the spatial and temporal overlap between them and thereby increase the modulation efficiency.

In a third aspect, a semiconductor modulator in accordance with the second aspect is used as part of an interferometer-based optical encoder for encoding an optical input signal with a radio frequency modulation signal. The encoder comprises:
a first interferometer arm comprising a signal modulator in accordance with the second aspect;
a second interferometer arm comprising an optical phase shifter coupled to an optical attenuator or optical amplifier, the phase shifter allowing an adjustment of a phase of an optical signal in the phase shifter, the attenuator or amplifier allowing an adjustment of the amplitude of an optical signal in the attenuator or amplifier;
an input port and splitter for splitting the input signal into a first signal part and a second signal part for coupling into the first arm and second arm, respectively;
an optical output port for combining an output from the first arm and an output from the second arm.

Such an encoder enables a (near) background-free encoding of the optical input signal using the radio frequency modulation signal.

The same considerations that apply to the signal modulator also apply to the interferometer-based optical encoder. For instance, the coupling of the radio frequency modulation signal advantageously takes place with low loss. Similarly, co-propagation of the optical input signal and the radio frequency modulation signal can increase modulation efficiency, and so on.

Note that the invention does not depend on the absorption of the optical input signal being reduced or increased. The invention relies on the fact that there is a change at all (as opposed to no change). The discussion above applies to both ground and excited states in both the valence band(s) and conduction band(s), and the states involved in providing the change in absorption of the optical input signal need not be ground states, but may just as well be excited states.

### BRIEF DESCRIPTION OF THE FIGURES

FIGS. 1a and 1b illustrate schematically a semiconductor structure for use in the present invention.

FIGS. 2a-d schematically illustrate geometries for realizing a method in accordance with the present invention.

FIGS. 3a and 3b schematically illustrate changes in wavefunctions in a quantum confinement region when an electric field is applied across the region.

FIG. 4 illustrates schematically a semiconductor nanostructure element, a quantum dot, for use as a part of the present invention.

FIG. 5 illustrates amplitudes of the ground state wavefunctions for electrons and holes along the z direction of the quantum dot shown in FIG. 4, when no electric field is applied along the z axis.

FIGS. 6a and 6b represent amplitudes of calculated electron and hole wavefunctions in the x-y plane for the quantum dot in FIG. 4 when no electric field is applied along the x axis.

FIGS. 7a and 7b represent amplitudes of calculated electron and hole wavefunctions in the x-y plane for the quantum dot in FIG. 4 in the presence of an electric field of 100 kV/cm applied along the x axis.

FIG. 8 illustrates the dependencies of overlap integral of the electron and hole wavefunctions, and squared overlap integral of the electron and hole wavefunctions on the electric field applied along x axis for the quantum dot in FIG. 4.

FIG. 9 illustrates the derivative of the squared overlap integral of the electron and hole wavefunctions, with electric field applied along x axis for the quantum dot in FIG. 4.

FIG. 10a shows the dependency of the Stark shift on electric field applied along x axis for the quantum dot in FIG. 4.

FIG. 10b shows the derivative of the Stark shift with respect to electric field applied along x axis for the quantum dot in FIG. 4.

FIG. 11 illustrates the influence of the quantum-confined Stark effect.

FIG. 12 shows an RF-to-optical encoder, here shown in the configuration involving the interferometer.

FIG. 13a-c illustrates various electrodes configurations for applying a pre-bias field to the semiconductor nanostructure region of an RF-to-optical encoder, for example such as that in FIG. 12.

FIG. 14 shows RF signals representing a single RF pulse and a pulse train.

FIG. 15 shows the output signal obtained by encoding the RF pulse and pulse train from the top and bottom part of FIG. 14, respectively, onto an optical carrier, using an RF-to-optical encoder as shown in FIG. 12.

FIG. 16 shows a section of the optical carrier used for the calculation shown in FIG. 15. The upper part of FIG. 16 shows a corresponding section of the encoded optical signal from the top part of FIG. 15 (single pulse).

FIG. 17 shows power spectra of the optical carrier shown in the lower part of FIG. 16 and the optical output signals shown in FIG. 15.

FIG. 18 shows an amplitude spectrum corresponding to the single RF pulse shown in FIG. 14, and it shows an amplitude spectrum corresponding to the pulse train shown in FIG. 14.

FIGS. 19-26 relates to an experiment demonstrating the principle of, as well as an embodiment according to, the invention.

FIG. 19 is a schematic illustration of the proof-of-principle experiment set-up.

FIG. 20 is a schematic illustration of the sample representing the semiconductor structure in the proof-of-principle experiment.

FIG. 21 shows graphs of (upper graph) the electric field of an RF signal as experienced by the QDs in the sample, and (lower graph) the change in the optical reflectivity due to the modulation of the absorption in the QD region of the sample by the electric field of the incoupled RF signal. Individual RF signal pulses in the sequence and relative amplitudes of individual reflectivity modulation signals in the sequence do not need to scale as shown.

FIG. 22 is a graph showing the small-signal reflectivity spectrum of the sample, and spectrum of the optical pulse used for probing the reflectivity change of the sample, change being induced by the incident RF signal.

FIG. 23a and b show the electric field of an incident RF signal and the change in the reflectivity, AR, of the nanostructure region of the sample experienced by a laser pulse.

FIG. 24 shows the measured change in reflectivity of the QD device, used as sample in this experiment, induced by the multiple reflections of RF pulses in the QD device.

FIG. 25 shows the spectral response—result of Fourier transform of the time-domain data shown in FIGS. 23 and 24.

### DETAILED DESCRIPTION OF THE INVENTION

In the following, the invention is described through examples. The examples shall not be construed as imposing limits on the scope of the invention defined by the claims.

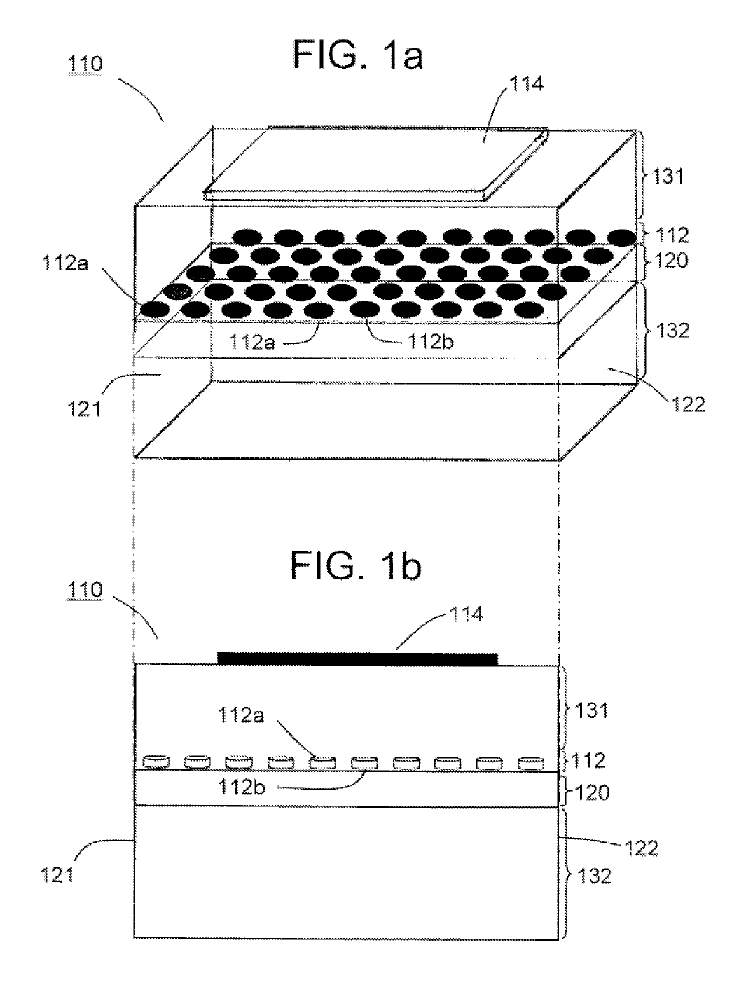

FIG. 1a schematically illustrates a semiconductor structure 110 for use with the present invention. It comprises material regions 131 and 132, with a semiconductor nanostructure region 112 of semiconductor nanostructure element(s) 112a, 112b. The semiconductor structure in fig. la also has a region 120 which can assist in increasing the interaction between an optical input signal propagating through the structure, and the nanostructure region that provides absorption. The structure 110 has a first optical, input interface 121 for coupling the optical input signal into the structure and a second optical, output interface 122 for coupling a non-absorbed part of the optical input signal out of the structure. The structure also has a receiver element 114, shown here as a flat element, for receiving a radio frequency signal and facilitate low loss coupling of the RF signal into the nanostructure region 112. The receiver 114 together with the rest of the semiconductor structure should be designed to efficiently receive radio frequency signals of at least one wavelength and couple the received signal into the nanostructure region to provide the electric field associated with the RF signal into the nanostructure region 112, or at least a part thereof. The first input optical interface 121 and the second output optical interface 122 can also be the same element, if the optical signal will enter the structure 110 through the interface, experience reflection within the structure 110, and leave through the same inteface, as is used in the proof-of-principle experiment reported later.

The elements in FIG. 1a have been shown as transparent, partly in order to reveal the nanostructure elements such as 112a and 112b of the nanostructure region 112. FIG. 1b illustrates the structure from FIG. 1a in a side view.

The receiver element 114 needs not necessarily be a separate element. The semiconductor structure itself can act as the receiving element. A prism or other suitable optical element can also be used as a receiver element. A coating on the semiconductor structure is also an option. This is a matter of design.

The receiver element 114, in all its embodiments, serves to reduce or eliminate the reflection loss of the incident wireless RF signal by providing an efficient impedance matching for the incident RF signal. Below, some preferred embodiments of receiver element 114 using special coating on the semiconductor structure 110 are described:
a specialized metallic antireflection coating, as in the work Kroll et al., “High-performance terahertz electro-optic detector”, Electron. Lett. vol. 40, pp. 763-764 (2004)
a semiconductor layer having an optimum concentration of free carriers, either provided by the doping, or by optical excitation as in the work Fekete et al., “Active optical control of the terahertz reflectivity of high-resistivity semiconductors”, Opt. Lett. vol. 30, pp. 1992-1994 (2005)
an interference-based dielectric coating layer or a multilayer structure, similar to the one demonstrating high reflectivity in the work Turchinovich et al., “Flexible all-plastic mirrors for the THz range”, Appl. Phys. A: Materials Science and Processing, vol. 74, pp. 291-293 (2002) and in the patent U.S. Pat. No. 6,954,309 (B2), but in the anti-reflection coating arrangement

In some cases, it may be desirable to couple the radio frequency signal into the semiconductor structure codirectionally, or substantially so, with the optical input signal. In such embodiment, the first optical interface can be adapted to act as the receiver element 114; a suitable coating or structuring on the semiconductor structure, for instance formed on the first optical interface, can also be used as a receiver element.

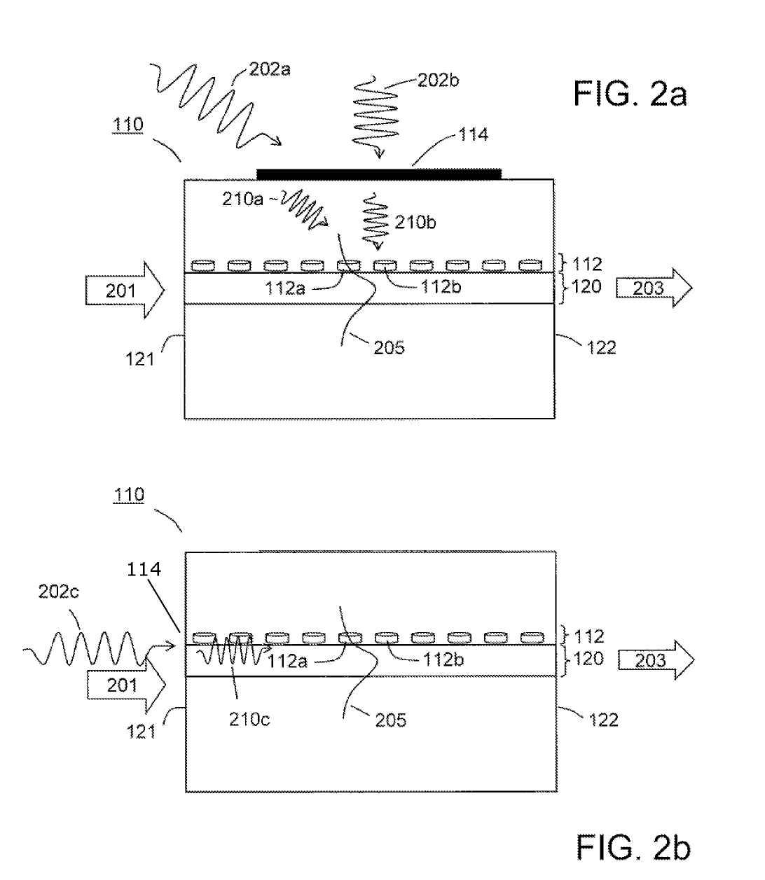

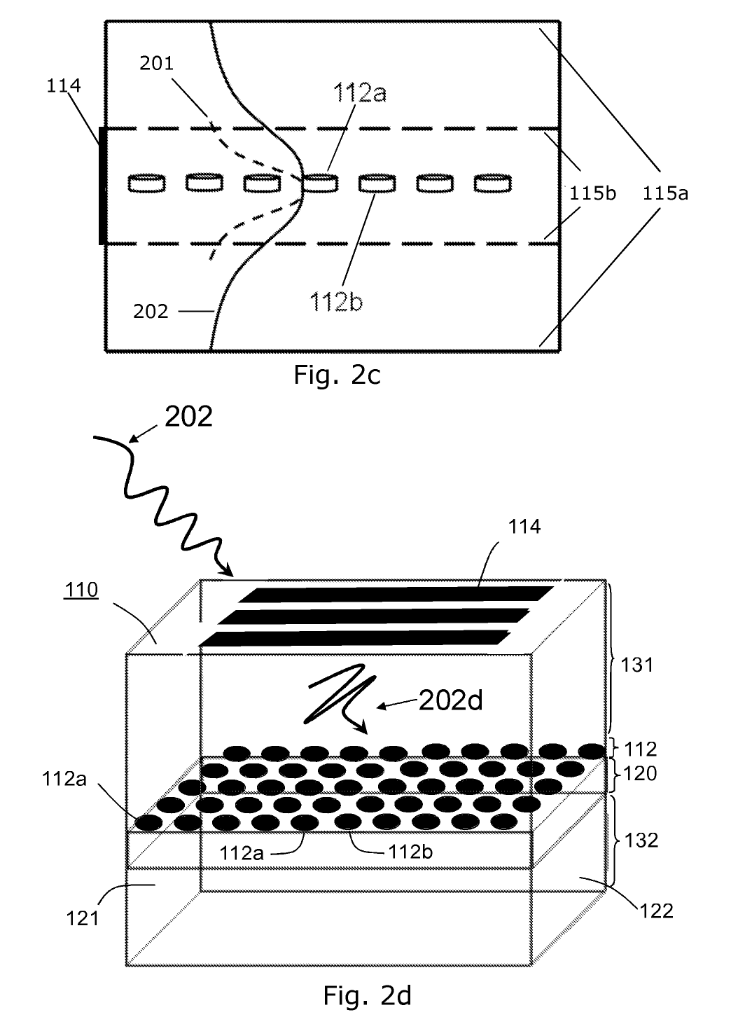

The advantage of coupling the RF signal and the optical signal into the semiconductor structure codirectionally is in increase of the interaction length of the RF and optical signals while propagating through the part of the structure, comprising the semiconductor nanostructures, as shown in FIG. 2b. In this case, the receiver element 114 can be an optimized waveguide or a part thereof. The waveguide will ensure that both optical and RF signals are guided through the semiconductor nanostructure region in a manner that the sufficient part of the intensities of both signals is confined to the semiconductor nanostructure region. An increased interaction efficiency will be achieved, if both RF and optical signal propagate over longer distances with the same or close enough group velocities. A dual waveguide structure can be used, for example, where the optical and RF signals will be guided in a codirectional manner by the overlapping individual waveguides, each tailored to optimize the propagation of either RF or optical signal. An example of such dual waveguide structure is shown in FIG. 2c. Here, 115a and 115b are waveguide boundaries for the propagating RF signal 202, and optical signal 201.

FIG. 2a illustrates an optical input signal 201 to enter the structure 110, and an optical output signal (203) resulting after the optical input signal has propagated through the structure. A radio frequency signal such as 202a or 202b is received by the receiver element 114 and coupled into the semiconductor structure as illustrated by signals 210a and 210b, respectively. It reaches the nanostructure region where, as described previously, it provides changes in the optical absorption in least a part of the nanostructure region. The optical input signal 201 (also illustrated in this example as a guided signal 205) propagates from input interface 121 to output interface 122, and experiences the change in absorption in the structure under the influence of the electric field of the RF signal 210a, 210b.

FIG. 2b illustrates an RF signal 202c being coupled into the semiconductor structure codirectionally with the optical input signal 201 giving a signal 210c in the nanostructure region.

The electric field of the incident wireless RF signal applied to the semiconductor nanostructure elements can even be locally enhanced by using a receiver element 114 comprising at least one metallic nano slit and being positioned close enough to the semiconductor nanostructures so that it will lead to a local concentration of an electric field at the semiconductor nanostructures. This principle is demonstrated in the work Seo et al. “Terahertz field enhancement by a metallic nano slit operating beyond the skin-depth limit”, Nature Photonics, vol. 3, pp. 152-165 (2009). In this case, the efficiency of our method of modulation of optical properties of semiconductor nanostructures by the electric field of a wireless RF signal can be further increased, thus requiring weaker wireless RF signals to provide larger modulation of optical properties of semiconductor nanostructure. One possible embodiment using an incoupling element 114 comprising the metallic nano slits is shown in FIG. 2d. Here, the semiconfuctor structure is the same as in FIG. 1. The incident wireless RF signal 202 is locally enhanced by the receiver element 114 comprizing at least one metal nano slit, and the semiconductor nanostructures 112a, 112b positioned close enough to the nano slit are subject to the stronger RF signal 202d.

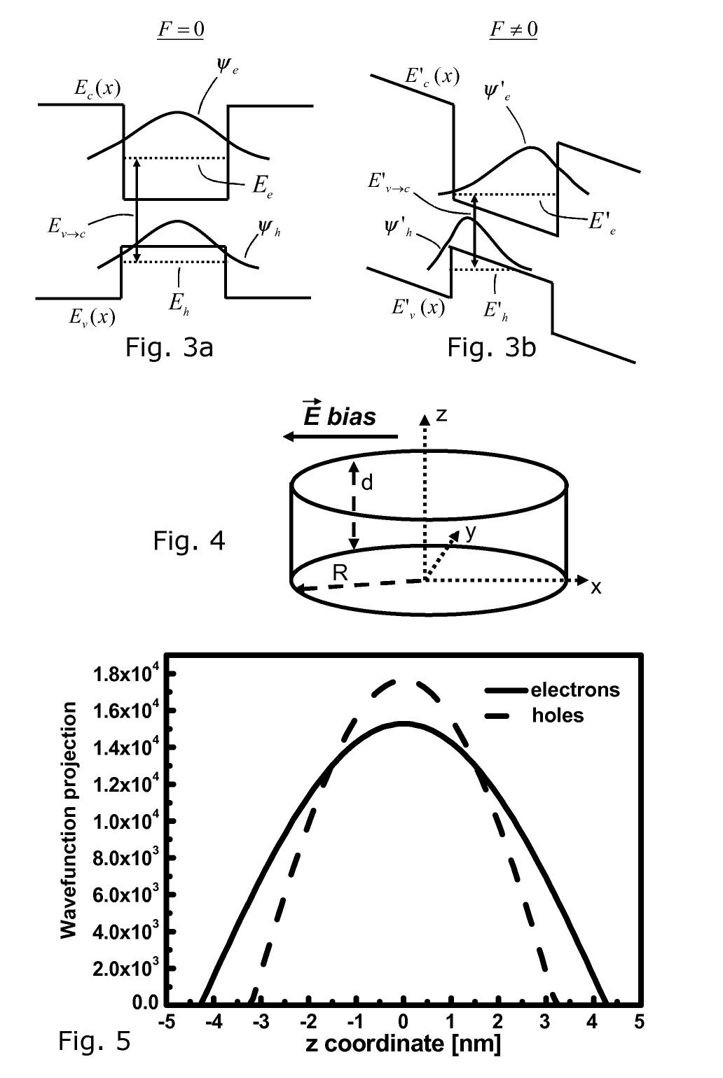

FIG. 3a illustrates schematically the conduction band potential, E_{c}(x), of the semiconductor nanostructure, and the valence band potential, Eᵥ(x), of the semiconductor nanostructure, along an axis, x, in the absence of an electric field, i.e. F=0. These potentials E_{c}(x) and Eᵥ(x) provide the quantum confinement of electrons and holes, respectively, along the dimension x. FIG. 3b illustrates the corresponding potentials, E′_{c}(x) and E′ᵥ(x), in a non-zero electric field, F≠0. Under the conditions in FIG. 3a, there is a quantum dot conduction band state with wavefunction ψₑ and eigenenergy Eₑ, and a quantum dot valence band state with a wavefucntion ψₕ and eigenenergy Eₕ. The former can be referred to as (Eₑ,ψₑ) and the latter as (Eₕ,ψₕ). A corresponding transition energy is Eₑ−Eₕ.

A photon having this energy can excite an electron from the quantum dot valence band state (Eₕ,ψₕ) to the quantum dot conduction band state (Eₑ, ψₑ), and will thus be absorbed with a probability that is proportional to the square of the overlap integral of the wavefunctions ψₑ and ψₕ.

FIG. 3b illustrates the situation in the presence of a non-zero electric field, F≠0. The conduction band energy along the x-axis is E′_{c}(x), and the valence band energy along the x-axis is E′ᵥ(x). There quantum dot conduction band state has a wavefunction ψ′ₑ and an eigenenergy E′ₑ, and the quantum dot valence band state has a wavefunction ψ′ₕ and an eigenenergy E′ₕ. A corresponding transition energy is E′ₑ−E′ₕ. A photon having this energy can excite an electron from the quantum dot valence band state (E′ₕ,ψ′ₕ) to the quantum dot conduction band state (E′ₑ,ψ′ₑ), and will thus be absorbed with a probability that is proportional to the square of the overlap integral of the wavefunctions ψ′ₑ and ψ′ₕ.

FIGS. 3a and 3b are schematic, and the quantum dot is illustrated as a one-dimensional potential well. As described previously, a quantum dot is characterized in that a portion of material is entirely surround by material(s) having higher bandgap energy than that of a quantum dot, that is, the potential well is three-dimensional. A necessary feature is the obtained shift of the electron-hole transition energy and/or the shift in optical transition probability (through a change in the overlap between electron and hole wavefunctions) with the change in applied electric field across at least one quantum confinement dimension of the nanostructure.

In the following, the quantum-confined Stark effect is illustrated for a disc-like quantum dot. The quantum dot material is In_{0.54}Ga_{0.46}As with a bandgap energy of 0.74 eV, and the barrier material is GaAs with a bandgap energy of 1.42 eV. The quantum dot is cylindrical and has a radius of 7.5 nm and a height of 5 nm. The effective masses for electrons and holes in the quantum dot material are assumed to be 0.045 m₀ and 0.38 m₀, respectively, where m₀ is the rest mass of an electron. The effective masses in the barrier material are assumed to be 0.067 m₀ for electrons and 0.51 m₀ for holes. The ratio between the conduction band offset and the valence band offset between the quantum dot material and the barrier material is assumed to be 60/40.

FIG. 4 schematically illustrates such a quantum dot. The cylinder illustrates the quantum dot material, and its surroundings illustrate the barrier material. The applied electric field is assumed to be in the plane of the quantum dot, i.e. perpendicular to the dimension d. In the following we will assign this plane to orthogonal coordinates x and y. The field is applied along the x axis, as shown in FIG. 4 by field F.

Wavefunctions and eigenenergies for the ground state of electrons and holes in the quantum dot without and in the presence of the electric field are found by solving a Schrödinger equation. Methods for solving the Schrödinger equation can be found for example in Shun Lien Chuang, “Physics of Optoelectronic Devices”, John Wiley & Sons, Inc., pp. 94-95, (1995). The penetration of the wavefunctions for electrons and holes into the barriers is taken into account by the following approximation: introducing a larger effective radius of the quantum dot, which is different for electrons and holes, and then solving the Schrödinger equation for the quantum dot with infinite potential barriers, but having the larger effective dimensions. The particular choice of calculation approach is not essential to the scope to the invention. The calculations are merely included to illustrate the underlying principle.

FIG. 5 shows the amplitudes (in arbitrary units) of the ground state wavefunctions for electrons and holes along the z direction, in the absence of electric field applied along this dimension. In the present approximation and geometry these amplitudes are independent of an electric field component in the x-y plane, i.e. perpendicularly to the z direction, and are only determined by the band offsets, effective masses for the electrons and holes, and by the height, d, of the quantum dot.

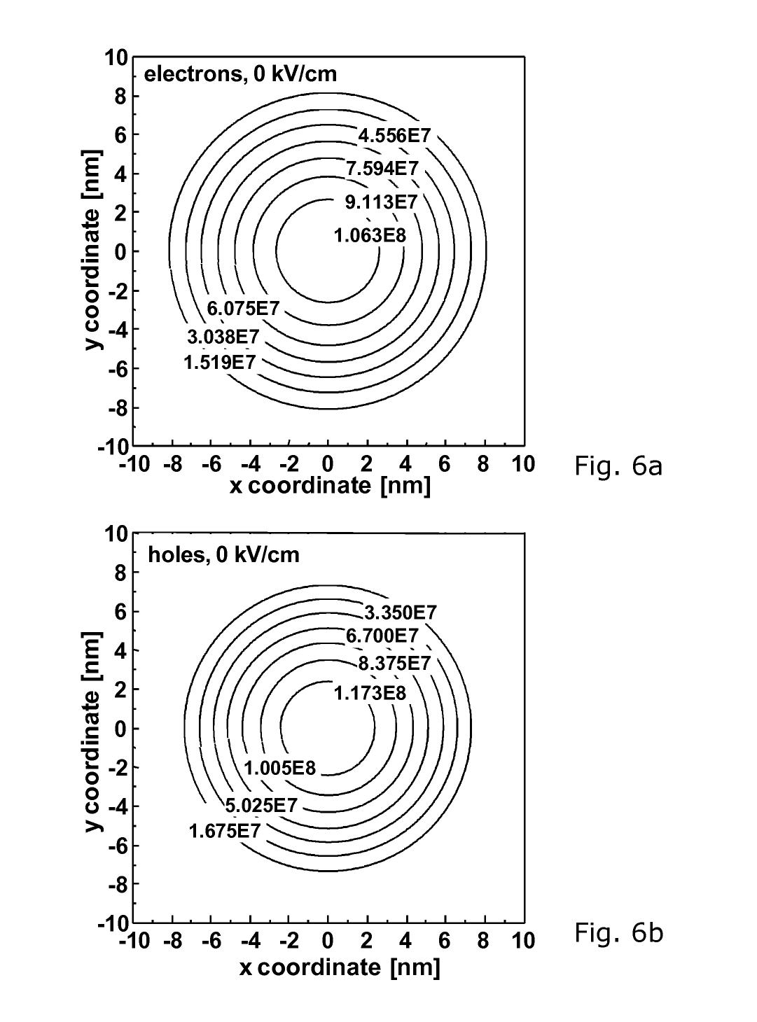

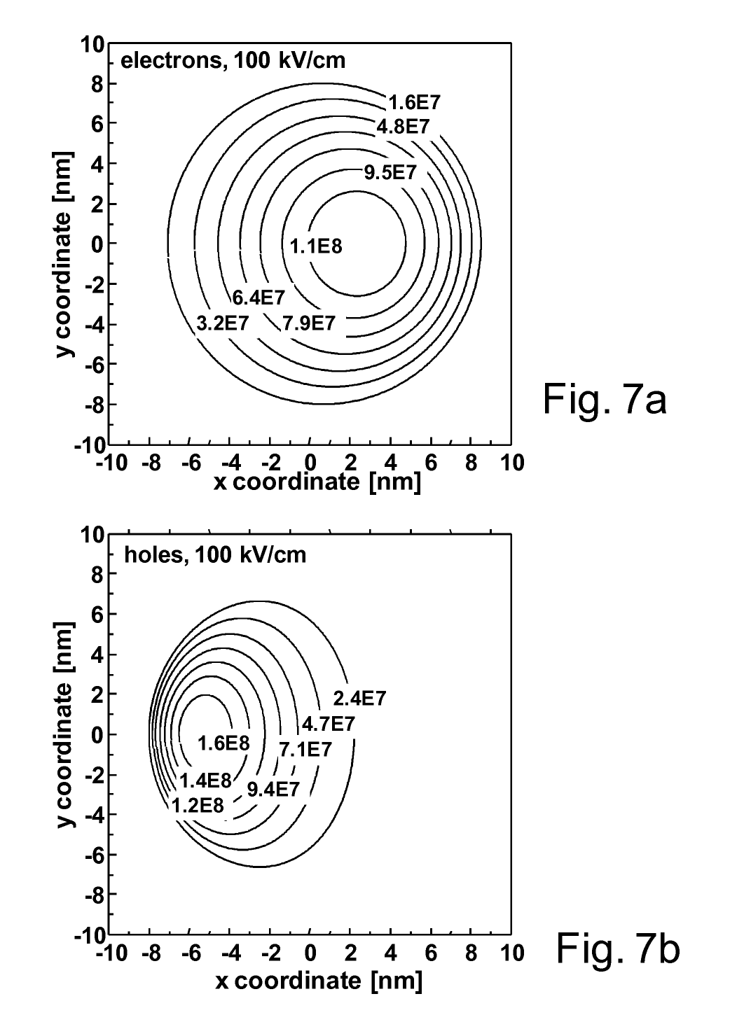

FIGS. 6a and 6b represent the amplitudes (in arbitrary units) of the calculated electron and hole wavefunctions in the x-y plane for the case where no electric field is applied along the x axis. FIGS. 7a and 7b represent the amplitudes (in arbitrary units) of the calculated electron and hole wavefunctions in the presence of an electric field (bias field, F_{bias}) with a field strength of 100 kV/cm directed along the x axis as shown in FIG. 4. A displacement of the electron and hole wavefunctions can be observed when the electric field is applied (compare with FIGS. 6a and 6b where the electric field is zero).

The overlap integral between the electron and hole wavefunctions is

$$M = {\int \int \int }_{x , y , z} {ψ}_{e} {ψ}_{h} d x d y d z .$$

This is reduced when the electric field is applied as a consequence of the displacements of the electron and hole wavefunctions. The wavefunctions at zero electric field and non-zero electric field, respectively, can be inserted into the equation above in order to calculate the overlap integrals in the two cases.

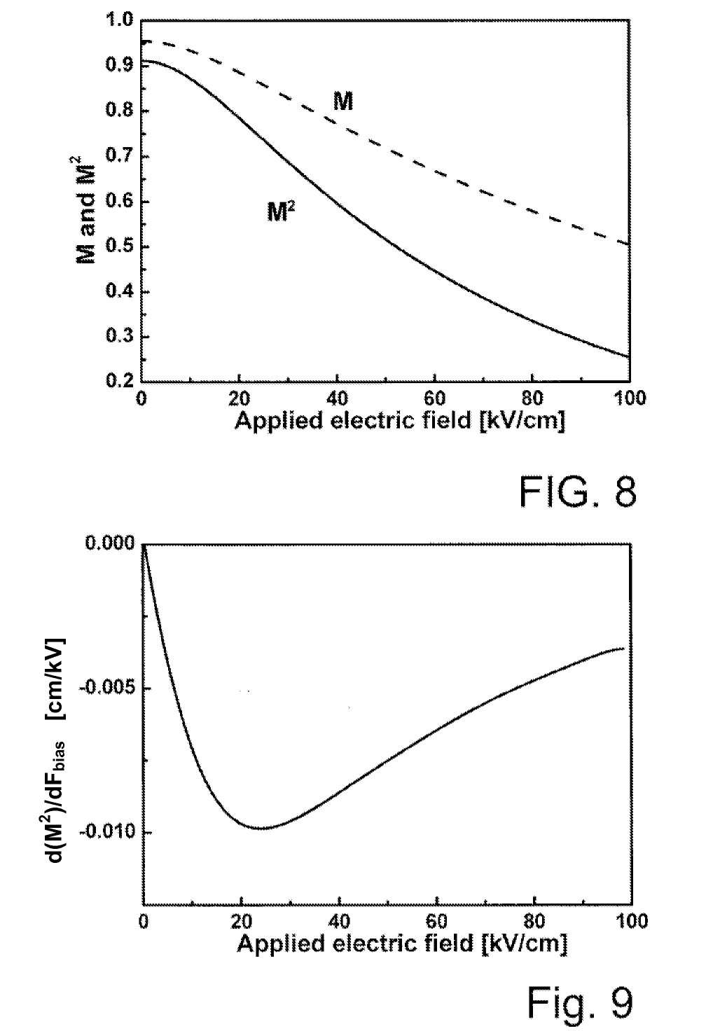

The optical transition strength, on which the absorption and recombination rates depend strongly, is proportional to the square, M², of the overlap integral M. FIG. 8 illustrates the dependencies of M and M² on the applied electric field for the quantum dot referred to above. The electric field being applied in the configuration described above. As can be seen, both M and M² decrease with an increase in applied electric field.

FIG. 9 shows the derivative,

$$\frac{d ( {M}^{2} )}{d {F}_{bias}} ,$$

of the square of the overlap integral M² with respect to electric field. This derivative describes the change in the optical transition strength, which is proportional to M², induced by a change in applied electric field, as a function of applied electric field. As can be seen from FIG. 9, the

$$\frac{d ( {M}^{2} )}{d {F}_{bias}}$$

has a minimum at the value of applied electric field of 24 kV/cm. If the quantum dot is biased at this level (“pre-biased”), then a small additional external RF signal having an electric field (co-polarized with the pre-bias electric field) will provide the strongest possible modulation of the optical transition strength. Use of such a pre-bias can thus assist in optimizing the modulation that the RF signal can incur on an optical signal having a frequency that is in the vicinity of the frequencies corresponding to the energies Eₑ−E_{h and E′}ₑ−E′ₕ. The pre-bias can be both static and time-varying.

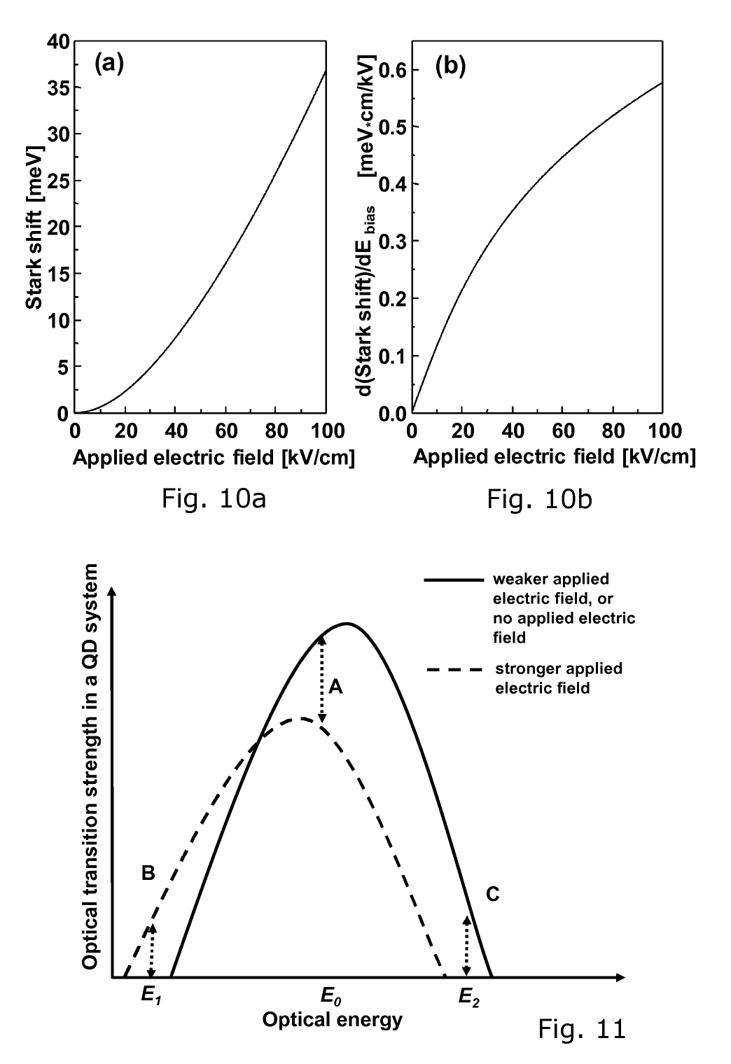

Another manifestation of the QCSE is a change (typically a decrease) in the optical transition energy with applied electric field. This shift of the optical transition energy with applied electric field, relative to the optical transition energy without an electric field, is referred to as a Stark shift. FIG. 10a shows the dependency of the Stark shift on applied electric field. FIG. 10b shows the derivative of the Stark shift with respect to applied electric field, as a function of applied electric field. These calculations were performed for the quantum dot system described above. The Stark shift increases monotonously with applied electric field. The derivative of the Stark shift on applied electric field also increases monotonously as a function of applied electric field. This means that the stronger variation of the Stark shift of the quantum dot system can be obtained (at least for a weak RF signal) if the system is already pre-biased with a strong electric field, co-polarized with the RF signal.

FIG. 11 illustrates the influence of the QCSE on the quantum dot system, where it is assumed for simplicity that there is only one electronic transition, namely between the valence band ground state and the conduction band ground state, which are the only two states that exist in this example. The homogeneous and inhomogeneous broadening that are in reality always present in a quantum dot system lead to broadening of the optical absorption spectrum of the semiconductor structure, which is advantageous for the modulation when the RF signal and/or the optical input signal are spectrally broad. Broadening of the optical absorption spectrum might be caused for instance by presence of near-lying electronic transitions, temperature, optical excitation strength, size variations of quantum dots in the nanostructure region, etc.

Generally, the RF signals 210a, 210b, 210c, which will modulate the optical transition strength in the quantum dot system, can be applied as an incident free-space propagating RF modulation signal as shown in FIGS. 2a and 2b (as 202a, 202b, 202c). The main application of the invention is in direct encoding of the RF wireless signal incident on the structure comprising the semiconductor nanostructures, and having a receiver element 114, from the free space. However, the RF signal can also be supplied to the structure as an time-varying electric field applied from an RF waveguide of any sort, such as a parallel plate waveguide, striplines, fiber etc. A RF signal guided in any of these are considered wireless within the meaning of the present invention, as the electromagnetic waves of the RF signal are only guided by the waveguide by means of internal reflection or similar mechanism. Electric signals, as used in the prior art references, propagates by movement of electric charges and are restrcted to propagate inside conducting materials. These are therefore not wireless and are also referred to as hard wired signals. Electromagnetic signals, on the other hand, are emitted by movement of an electric charge, but as such propagate in any dielectric medium, i.e. without being confined to wires. It follows that a wireless RF signal must be an electromagnetic signal involving a fluctuating electric field and a fluctuating magnetid field. Electromagnetic signals do not suffer from the inherent limitations (such as RC constants) of electric voltage or current signals propagating in an electrically conducting material. However, electrically conducting materials can be used to guide electromagnetic waves in order to obtain a better power transmission.

There are also fundamental differences in how to apply a wireless signal and a hard wired signals over a structure such as an optical semiconductor structure. As shown in e.g. EP 1 416 316 and GB 2 386 965, the application of hard wired signals requires two electrodes sandwiching the semiconductor structure, and imply limitations on the design and material selection of the semiconductor structure.

The application of wireless signals requires that the signal is coupled into the semiconductor structure 110 by the receiver element 114, preferably at low loss. Several different embodiments of receiver element 114 are described in the above, some of which involves a metallic antireflection coating on the side of the semiconductor structure 110 receiving the wireless RF.

In a further embodiment, it is preferred to include a reflector made from an electrically conducting material positioned on the opposite side of the semiconductor nanostructure region from the receiving element 114. Such reflector can reflect RF radiation that has already traversed the nanostraucture region back towards the nanostraucture region. A distance between the surface and the reflector can be made very small, so that the interaction between the RF signal and the QDs (placed between the surface and the reflector) will effectively be similar to a “point interaction”, not leading to a sufficient time delay between the interactions. Such reflector provides the advantage of increasing the in-coupling the RF signal to the nanostructure region.

Hence, it is preferred that any metallic layers comprised by the receiver element 114 only performs the function of receiving a wireless modulation RF signal and couples it into the semiconductor structure 110, preferably at low loss. Similar, it is preferred that a metal reflector opposite the receiver element 114 only performs the function of reflecting RF radiation back towards the nanostructure region. Hence, it is preferred that any such electrically conducting layers are not connected to electrical circuitry by hard wires, such as to electrical circuitry for providing hard wired modulation signals. As the person skilled in the art will know, it might be necessary to make a ground connection to such electrically conducting layers to avoid uncontrolled electrical bias, alternatively it may be used as one of two or more electrodes used to apply a DC bias field as described elsewhere.

However, such ground or bias connection does not represent a connection to electrical circuitry for providing modulation signals.

The quantum dot system can be pre-biased as discussed above. A pre-bias field can be supplied statically or time-varying, in just the same way as the RF modulation signal, such as by another incident RF signal or otherwise supplied electric field (for instance through electrodes, RF waveguide, and so on). A combination of these approaches can be used to provide non-linear mixing whereby more complicated pre-bias fields can be induced.

Since both the pre-bias field and the RF modulation signal provide the modification of absorption conditions for the input optical signal in the semiconductor nanostructure region, a non-linear mixing of the RF modulation signal and a pre-bias field (which can be both static and time-varying) can be achieved, which will provide the according modulation of the optical input signal.

Another effect of applying an electric field to a quantum-confined system, such as a quantum dot system, is the electrorefraction effect, which is a local modification of the index of refraction that occurs when an electric field is applied. This effect is, like the QCSE, also nearly instantaneous, and follows the applied electric field with a very short delay (perhaps a few femtoseconds). This can contribute a phase shift to an optical input signal propagating through the semiconductor structure 110. In this way, the transmitted optical signal is also phase-modulated by the externally applied electric field (RF modulation signal or pre-bias field), contributing further to the modulation of the optical input signal

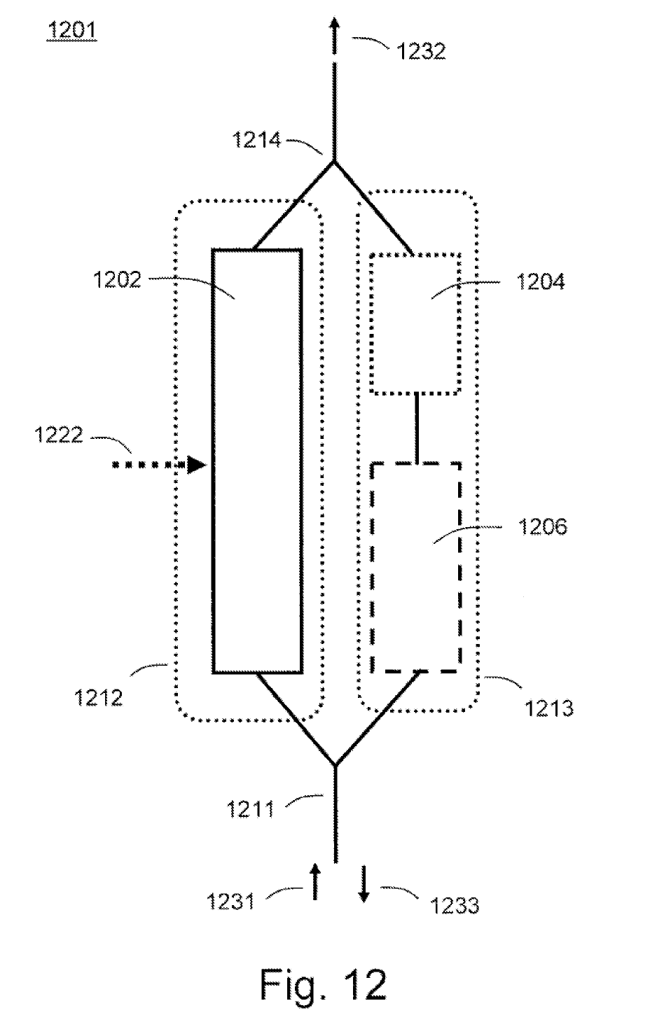

FIG. 12 shows an example of signal converter, more specifically an example of RF-to-optical encoder 1201 that uses the principles described above. This encoder allows a nearly background-free modulation of an optical signal. In this case, it will not allow for the unmodulated part of the input signal (in case of incomplete modulation) to propagate through the device. An optical input signal 1231 entering through an input port 1211 is split into two parts: a first part will be transmitted through a first arm 1212 comprising a semiconductor modulator 1202 in accordance with the first aspect of the invention. A second part is transmitted through a second arm 1213 comprising an optical phase-shifter 1206 and an attenuator/amplifier 1204. The relative positions of the phase-shifter and modulator in this series (i.e. which device is positioned first and which is positioned second) is optional and a matter of design, for instance for the purpose of optimization. The outputs of the arms 1 and arm 2 (1212, 1213) are combined together at an output port 1214 (which is a coupling point for arms 1 and 2) of the device to form an output signal 1232.

The RF-to-optical encoder 1201 should initially be adjusted before the wireless RF modulation signal is applied to the semiconductor modulator 1202 in the first arm. The phase-shifter 1206 can contribute an adjustable phase change of the second part of the optical signal in order for the phase difference between the first part and the second part of the optical signal differ by 180 degrees (or as close as practically possible) at the coupling point 1214. The attenuator/amplifier is used to bring the intensities of the optical signals at the output of the two arms 1212, 1213 as close as possible in order to make it possible to obtain (a near perfect) signal extinction at the coupling point 1214 by (near perfect) destructive interference. In this case, before application of the wireless RF modulation signal to the semiconductor modulator 1202 in the first arm, the total transmission of the optical carrier through the encoder 1201 will be zero (or as close to zero as practically possible). An optical isolator (not shown) can prevent the reflected light 1233 from escaping through the input port in the opposite direction.

Now, when a RF modulation signal 1222 is applied to the semiconductor modulator of arm 1 in accordance with the description above, then the transmission through the arm 1 will change due to the modulation obtained as described previously. This will contribute to an intensity difference between the first and second optical signals (the signals going through arm 1 (1212) and arm 2 (1213)). The optical phase difference between the optical signals in arm 1 and arm 2 is still 180 degrees (or very close to), but due to the absorption by the semiconductor modulator, there will be an imperfect destructive interference between the signals at the output of the arm 1 and the arm 2. Thus, a part of the intensity of the input optical signal will be transmitted through the device even when the destructive interference is at its highest. The level of transmission is associated with the modulation strength of the optical signal in the semiconductor modulator resulting from the applied RF modulation signal. Thus, the wireless RF modulation signal is only applied to the semiconductor modulator 1202 in the first arm, no RF modulation signal is applied to the optical phase-shifter 1206 and the attenuator/amplifier 1204 in the second arm.

The invention can be modified because a change in absorption for the optical input signal is intrinsically related to a change in the index of refraction. In this case, the semiconductor nanostructure region changes a phase of the optical input signal and not so much an intensity of the optical input signal. The RF modulation signal causes a change in the index of refraction even below the band gap of the nanostructure region elements. Thus, in this case the first frequency can be below the energy difference between the first valence band state and the first conduction band state and also below the energy difference between the second valence band state and the second conduction band state. This means that the modulation of the optical input signal is mainly a phase modulation, and not predominantly an intensity modulation. Even if the electrorefractive effect is predominant, then a similar arrangement can be used. In this case, in the absence of the modulating RF signal, the transmission through the output port 1232 must be brought to zero or as close to zero as possible, by suitable equalization of the transmission intensities transmitted through 1212 and 1213 using an attenuator/amplifier 1204, and the phases of the signals of in 1212 and 1213 must be brought to the phase difference of 180 degrees (or as close to as possible), by suitable adjustment of the phase-shifter 1206. In this case, signals propagating through the arm 1 (1212) and the arm 2 (1213) will experience complete (or as close to as possible) destructive interference, thus the total transmission through the output port 1232 will be as close to zero as it is possible. Now, if a modulating RF signal is applied to the modulator 1212, due to electrorefractive effect a phase of the optical signal through the arm 1212 will be shifted, according to the electric field strength supplied by the RF modulating signal. In this case, the destructive interference of the optical signals through 1212 and 1213 will become incomplete, which will allow for the optical intensity to propagate through the output port 1232. This optical signal will be time-modulated by the RF signal, and again, will have zero- or near-zero background.

Generally, a combination of QCSE and electrorefractive effects can be used to achieve the desirable RF-modulation strength of the transmitted optical signal at the output port 1232 using suitable optimization of the whole device and/or its elements.

The attenuator/amplifier 1204 can be made of the same material as the semiconductor modulator. The attenuation (or amplification) of the first optical signal in the arm 2 can be tuned by an applied electric field. This is well known, and an semiconductor electro-absorption modulator or semiconductor optical amplifier is well suited for this purpose. As a phase shifter 1206, a lithium niobate phase shifter or other suitable phase shifter can be used. The person skilled in the art will readily recognize that other attenuators (amplifiers) and phase shifters are suitable.

The waveguides, phase-shifter, and the attenuator can be realized on the same substrate (as schematically indicated in FIG. 12), or optically integrated in other ways. Alternatively, the parts can be subdivided and the individual components be arranged with intermediate waveguides to provide the required optical coupling between them. The person skilled in the art is well aware of such various ways.

FIG. 12 is schematic only. The interferometer arms, semiconductor modulator, phase shifter, attenuator and so forth are not to scale, neither individually nor in relation to each other.

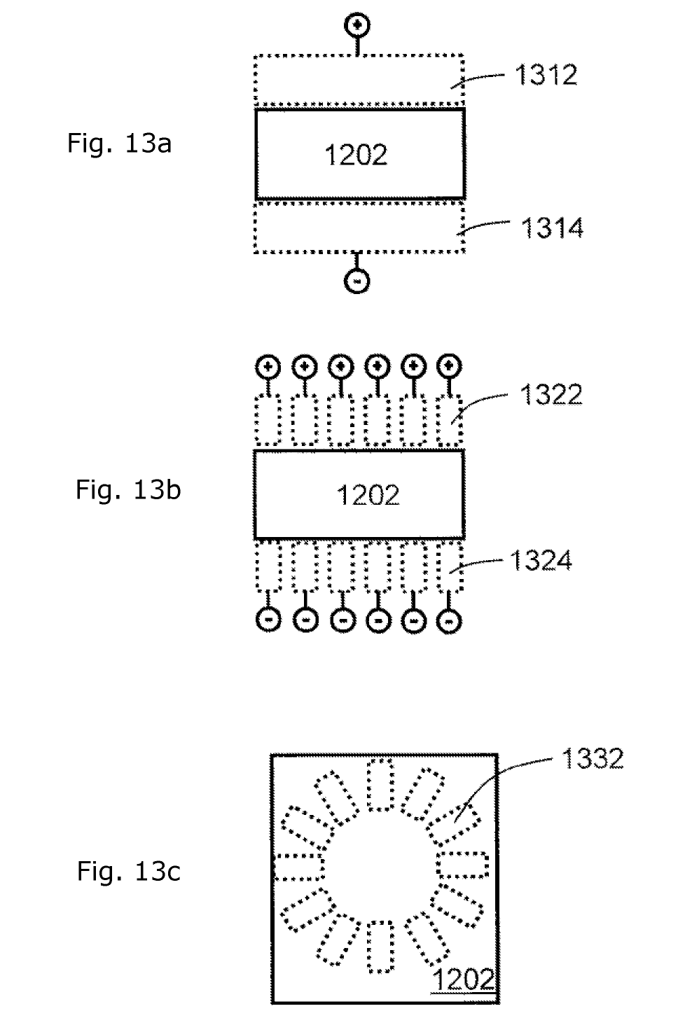

FIGS. 13a-c schematically show possibilities for pre-biasing the semiconductor nanostructure region of the signal modulator 1202 in FIG. 12, for allowing optimization of the modulation, as described above. It is important to understand that the electrodes used for pre-biasing are not related to the receiver element 114 for receiving a wireless modulation RF signal. The electrodes used for pre-biasing are adapted to receive a DC bias signal over hard wires and not a RF signal.

In FIG. 13a, two electrodes 1312 and 1314 are shown for application of a pre-bias electric field to the semiconductor nanostructure region of the modulator 1202 from FIG. 12. The optical signal propagates through the semiconductor nanostructure region as shown in FIGS. 2a and 2b (optical signal 205), entering at an interface 121 and leaving it at an interface 122. In this case, the electric field is applied along the whole length of the semiconductor nanostructure region of the modulator.

In FIG. 13b, a series of electrodes 1322, 1324 for application of pre-bias field to the semiconductor nanostructure region of the modulator is shown. In this case, the pre-bias electric field can be applied locally to different parts of the modulator, by applying a bias voltage (or different bias voltages) to some or all of the electrodes 1322 and 1324.

In FIG. 13c a circular pattern of electrodes 1332 is provided around the semiconductor nanostructure region of the modulator. The circular pattern allows for optimal orientation of the pre-bias field polarization with respect to that of the RF modulation field, by choosing a suitable set of electrodes among electrodes 1332. Thus, one will be able to match the polarization of the pre-bias electric field to that of the RF modulation field.

Numerical Simulation

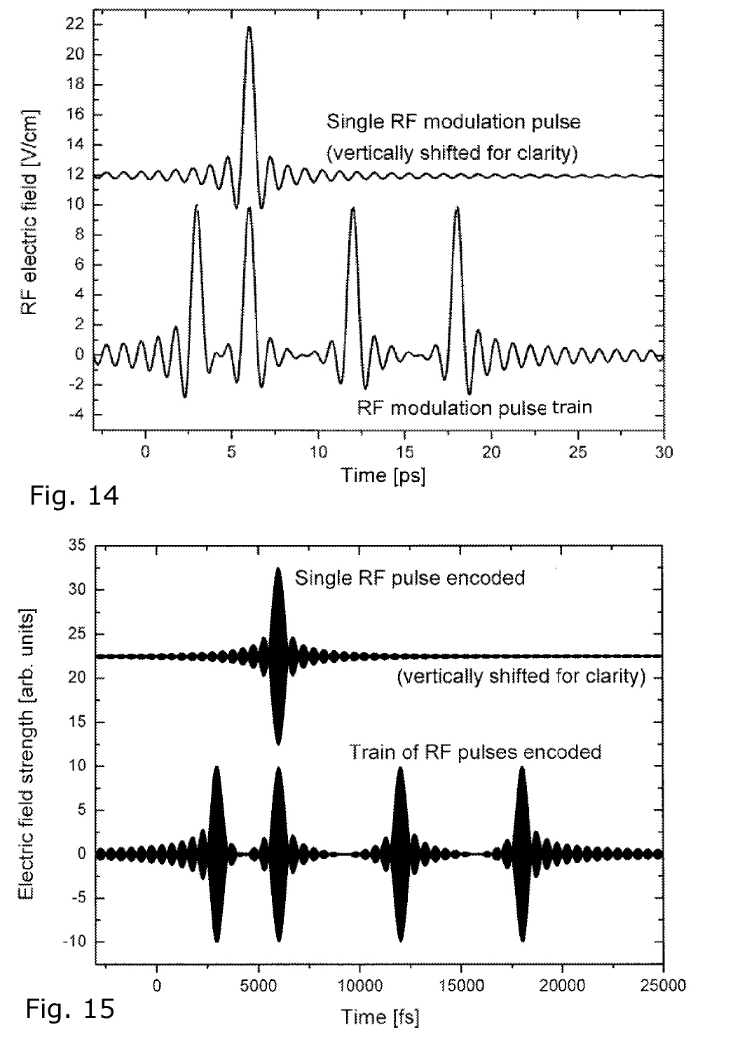

FIGS. 14-18 illustrate the invention with numerical calculations.

FIG. 14 shows RF signals representing a single RF pulse, and a pulse train (corresponding to the data transmitted at a rate of 0.33 Tbit/s). The peak electric field strength is 10 V/cm.

FIG. 15 shows the output signal obtained by encoding the RF pulse and pulse train from the top and bottom part of FIG. 14, respectively, onto an optical carrier with central wavelength of 1300 nm (approximately corresponding to an optical frequency of 233 THz) using the device shown in FIG. 12. A background-free signal is produced by the device. The quantum dot parameters are the same as described above. RF electric field is copolarized with a pre-bias DC electric field of 24 kV/cm (see FIG. 2b and discussion thereof).

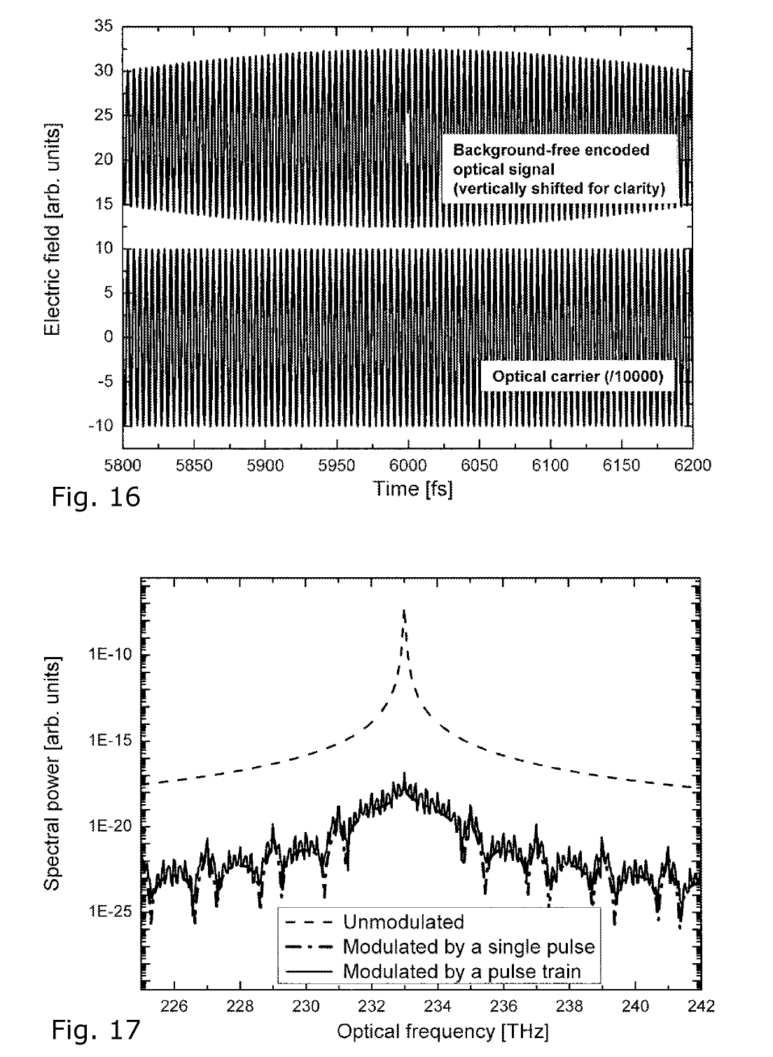

FIG. 16, lower part, shows a section of the optical carrier used for the calculation shown in FIG. 15. The upper part of FIG. 16 shows a corresponding section of the encoded optical signal from the top part of FIG. 15 (single pulse).

FIG. 17 shows power spectra (arbitrary units) of the optical carrier shown in the lower part of FIG. 16 and the optical output signals shown in FIG. 15.

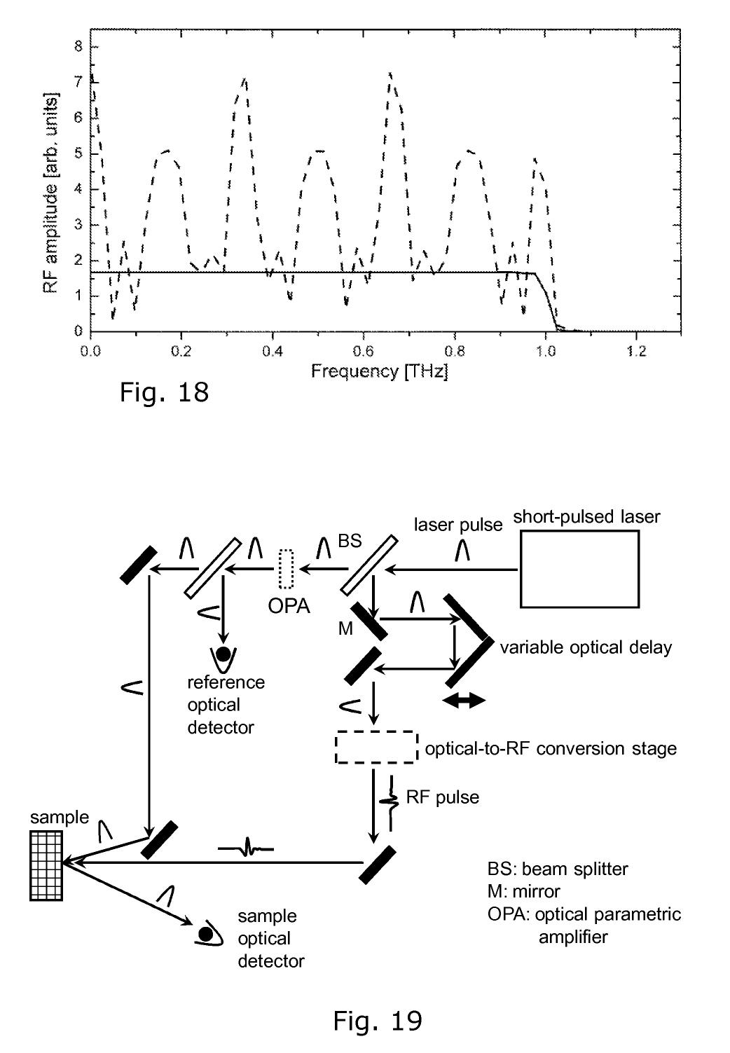

The full line in FIG. 18 shows an amplitude spectrum corresponding to the single RF pulse shown in FIG. 14, and the dashed line in FIG. 18 illustrates an amplitude spectrum corresponding to the pulse train shown in FIG. 14. The spectral features of these RF amplitude spectra are clearly reflected in the power spectra of background-free optical output signals from FIG. 17.

Proof-of-Principle Experiment

In the following, a description and results of a proof-of-principle experiment are presented.

In this experiment, a near single-cycle pulse of RF radiation (RF signal) was generated with the frequency spectrum covering the range 0.1-3 THz, by conversion of 80-fs long laser pulses with 800 nm central wavelength, provided by a pulsed laser, in an optical-to-RF conversion stage. The duration of the RF signal was not longer than 3 ps. The pulsed laser operated at the repetition rate of 1 kHz. Part of the laser output was frequency converted to the central wavelength of approximately 1040 nm (optical signal) using an optical parametric amplifier.

The duration of the optical signal was not longer than 100 fs. The RF signal was incident at normal incidence onto a sample representing the semiconductor structure 110. The optical signal was incident onto the sample at a small angle, and the power of the optical signal incident onto the sample, and reflected by the sample, was measured as a function of time delay between the RF and optical signal. The controlled time delay between the RF and optical signal was introduced using a variable optical delay line. The absolute value of the power of the optical signal incident and reflected onto the sample was measured using two optical detectors: reference and sample optical detectors, taking into account the optical signal transmission loss on the way to the sample. The schematic of the experimental setup is shown in FIG. 19. The experiments were carried out at room temperature, and the RF signals propagated through the atmosphere. No pre-biasing was applied to the sample, i.e. the sample did not experience any electric field, other than the one provided by the incident wireless radio frequency signal.

Also, no special receiver element for the incident RF signal was used, i.e. the receiver element was the sample surface itself.

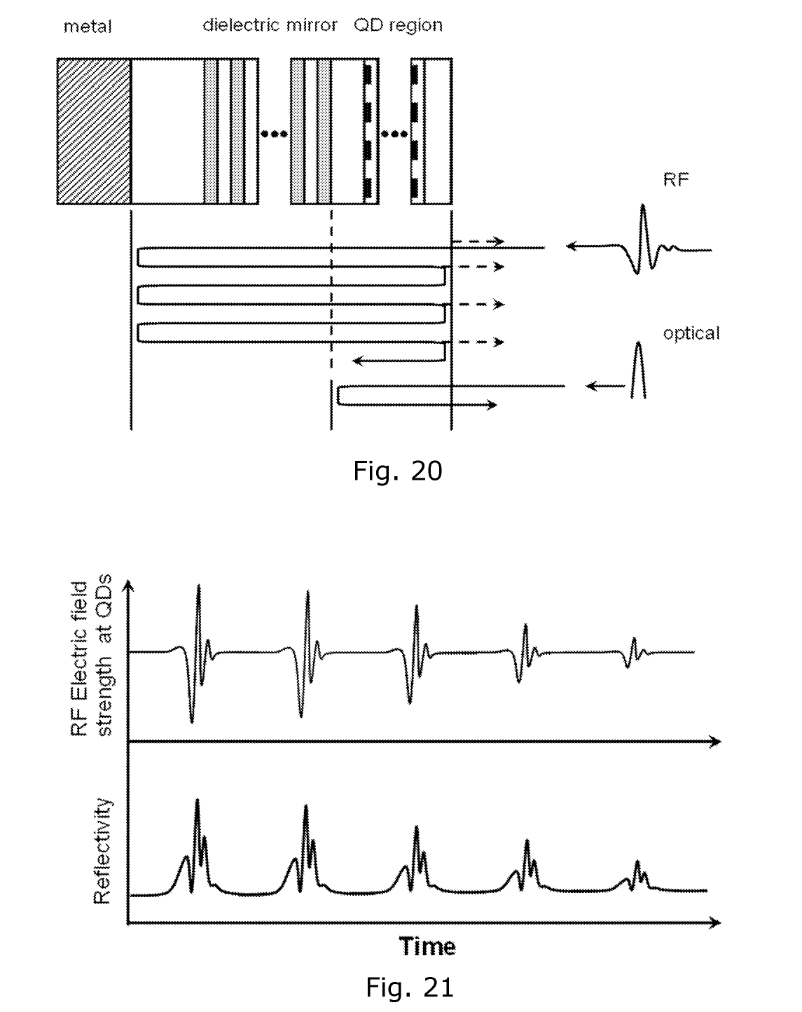

The sample in this experiment was a QD structure, shown in FIG. 20. All the semiconductor parts of the sample were undoped. The sample consisted of several layers of InAs/GaAs QDs, placed on top of a dielectric mirror. The dielectric mirror was grown on top of a bulk GaAs wafer, that was attached to the bulk piece of polished metal acting as a reflector for the RF signal. The dielectric mirror was grown so, that it reflects the optical signal with the central wavelength around 1040 nm with nearly 100% efficiency. The QDs, in turn, absorb the part of the optical signal as it propagates from the sample surface towards the dielectric mirror, and backwards from the dielectric mirror towards the surface of the sample. The surface of the sample was anti-reflection coated for the optical signal, which thus did not experience any reflection losses at the sample surface. The thickness of the part of the structure between the sample surface and the dielectric mirror, i.e. the part comprising the QDs, was on the order of the wavelength of the optical signal. Thus the interaction of the optical signal with the QDs on the roundtrip to and from the dielectric mirror can be considered as a point interaction, i.e. the time of propagation of the optical signal in the sample is negligibly small.

The RF signal, incident on the sample from a free space, experiences the reflection loss at the surface of the sample, propagates through the QD region, propagates through the dielectric mirror (which is not resonant with the RF frequencies), propagates through a thick GaAs wafer, and gets totally reflected off the metal reflector at the end of the sample, after which it propagates back, again propagating through the QD region, and then partially reflects back into the sample at the sample surface. Upon this reflection the elecrtric field of the RF signal re-entering the structure becomes smaller as the reflection coefficient of the sample surface is less than 1. The RF signal can also disperse, scatter, and attenuate as it propagates through the structure. Similarly, the optical pulse enters the device, passes through the QD region, reflects off the dielectric mirror (which does not affect the RF signal), passes through the QD region, and leaves the device, as the surface of the device is antireflection-coated for the wavelength of the optical pulse.

The distance between the QD region and the dielectric mirror is on the order of the optical signal wavelength, which leads to a negligibly small time delay for the interaction of optical pulse with QDs on the way in and out of structure (point interaction) The schematic showing the timing of interactions between the RF signal, and QDs, resulting in the corresponding change in the absorption in the QDs at the frequency of the optical signal is shown in FIG. 21.

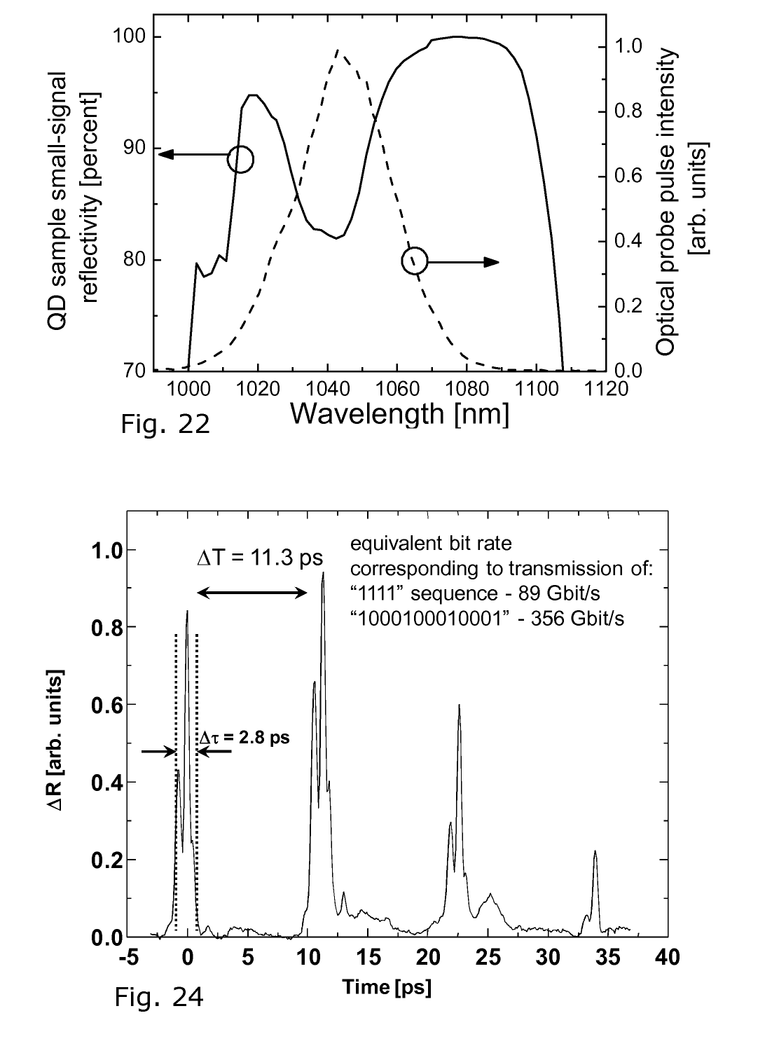

In FIG. 22 the small-signal reflectivity spectrum of the QD sample, and the intensity spectrum of the optical signal are shown. The dip in the reflectivity around the wavelength of 1040 nm is due to the optical absorption in the QDs. In our experiment we will demonstrate that the reflectivity of the QD sample around the wavelength of 1040 nm will increase when the QDs will be subject to the electric field of the RF signal. In other words, the QD absorption will be decreased as a result of interaction of the QDs with the electric field in the RF signal.

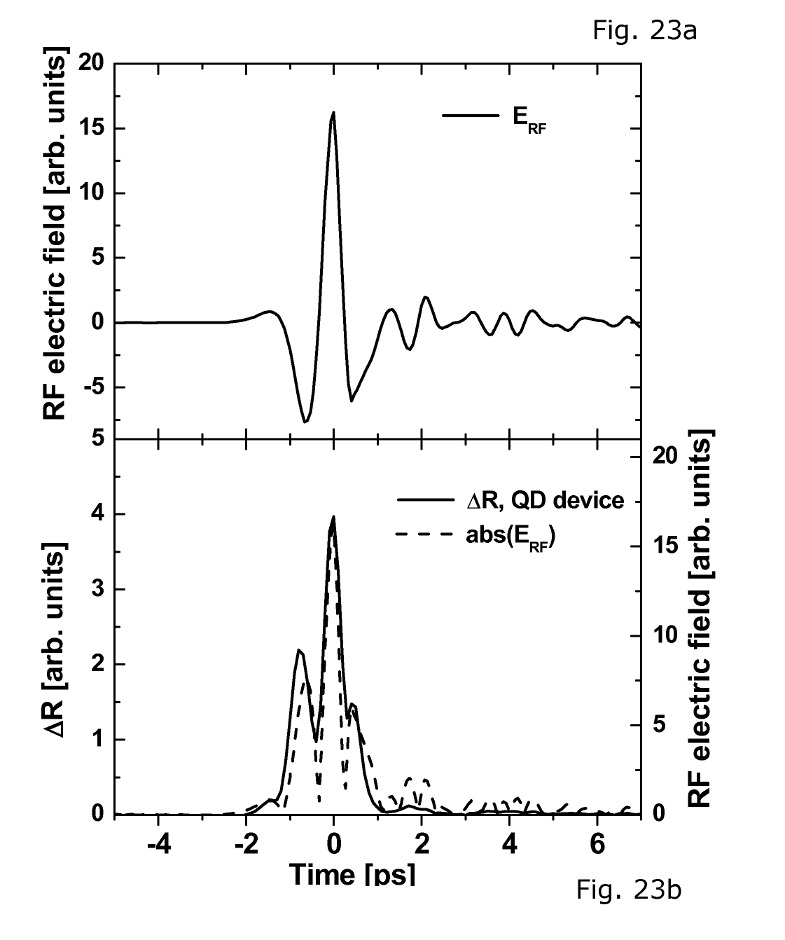

The first results of our proof-of-principle experiment are shown in FIGS. 23a and b. A temporal dependency of electric field of a near-single cycle RF pulse with the duration of approximately 2.8 ps is shown in FIG. 23a. The corresponding modulation of the reflectivity, ΔR, of the QD device around the wavelength of maximum absorption of the QDs, experienced by the optical signal of around 1040 nm wavelength, is shown in FIG. 23b as a function of time. We emphasize here, that the optical reflectivity change in the presence of the RF signal is positive, i.e. the optical absorption in the QDs is decreased, as compared to the situation when no electric field is applied. The absolute value of the electric field of the RF signal from FIG. 23a is also shown in this graph. The temporal dynamics of the optical reflelctivity of the QD sample clearly reproduces the main features of the absolute value of the electric field of the incident RF signal, and the reflectivity modulation signal has approximately the same duration as the incident RF signal. Above we outlined that the modulation of optical absorption in a QD sample without the initial electric pre-biasing (i.e. if no other electric field is applied to the QDs, except for the electric field of the incident RF signal) will be a decrease in the optical absorption, that will only depend on the absolute value of the electric field strength in the RF signal, and not on its sign. Thus the features with different polarities in the temporal dependency of electric field of RF signal from FIG. 23a lead to the positive change in the sample reflectivity (i.e. the reduction in QD optical absorption), shown in FIG. 23b. We have demonstrated here the instantaneous nature of encoding of the high-frequency RF wireless signal onto an optical signal, by inducing the corresponding modulation in the optical properties of the QD sample. The effect is, as predicted, coherent with the electric field of the RF signal, and the sub-ps—long features in the temporal dynamics of the RF signal can be reproduced by the signal associated with the modulation of optical signal absorption in the QDs. In this experiment we also have confirmed that the demonstrated RF-to-optical encoding effect is virtually independent of the mutual orientations of the electric field in RF and optical signal, and has a very weak dependency on the mutual orientation of the polarization of the optical signal in respect to the crystallographic axes of the sample, reflecting the small anisotropy of optical absorption in QDs.

In FIG. 24 we show the same measurement as presented in FIG. 23a and b, but taken over a longer time scale, where the QD region of the sample is a subject to multiple reflections of the RF pulse within the QD device, that are spaced in time approximately by 11.3 ps, resulting from multiple reflections of the RF signal in the structure as shown in FIGS. 20 and 21. We observe clear modulation in optical reflectivity of the QD sample each time the RF signal passes through the QD region of the device, following the interaction timing as in the sketch in FIG. 21. The individual reflectivity modulation pulses, spaced by 11.3 ps time intervals, feature slight reshaping, as a result of the disperision, scattering and attenuation, that the RF signal experiences within the structure. However, the approximate duration of the reflectivity modulation signals is always on the order of 2.8 ps. The results shown in FIG. 24 provide the evidence, that the encoding of a serial digital data stream, where each data bit is represented by a single RF signal pulse (“1”—RF pulse present in the sequence, “0”—RF pulse is not present in the sequence) is possible at the bit rate of at least 89 Gbit/s, corresponding to the temporal spacing between the data pulses of 11.3 ps, assuming “1111” sequence being transmitted. The ratio of the inter-pulse interval of 11.3 ps to the approximate duration of each individual reflectivity modulation pulse of 2.8 ps, 11.3/2.8=4.03, suggests the possibility of encoding the data at 4 times the demonstrated bit rate of 89 Gbit/s, i.e. at 356 Gbit/s=0.356 Tbit/s, without cross-talk between the optical reflectivity signals representing the data bits in the RF data sequence, encoded onto an optical signal.

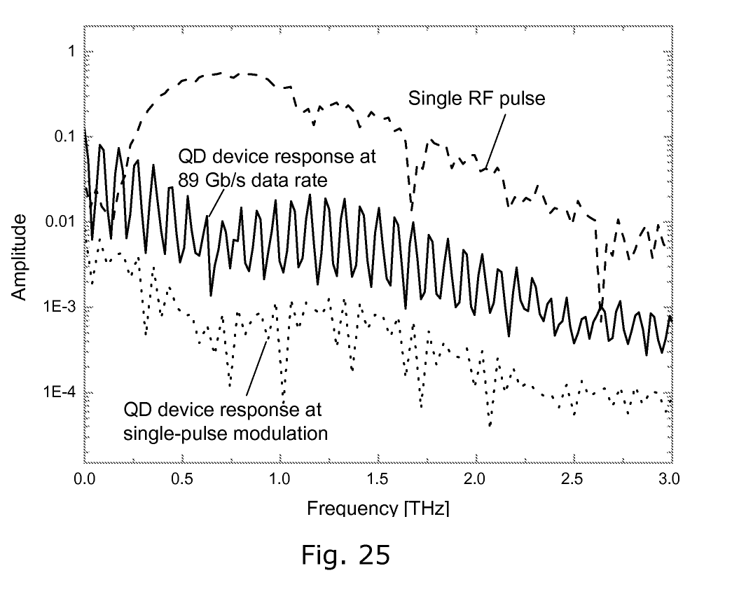

Finally, in FIG. 25 we demonstrate the frequency spectra (results of the Fourier transform of the time-domaini signals) of the individual RF electric field signal from FIG. 23a, the modulation of the optical reflectivity of the QD sample by a single RF signal from FIG. 23b, and of the same modulation but induced by a RF signal sequence from FIG. 24. The frequency spectrum of the individual RF pulse used in our experiment suggests that the bandwidth of approximately 3 THz can be used for encoding the information on the optical signal using proposed encoding method. In the spectrum of the reflectivity modulation produced by a series of RF pulses, the peaks spaced by approximately 90 GHz are clearly visible, corresponding to the possibility of the bit rate of 89 Gbit/s, shown in this experiment. The frequency spectra of the reflectivity modulation, induced by the single RF pulse, and a sequence of RF pulses, are equivalent to the modelled side-bands in the frequency spectrum of the optical signal, shown in FIG. 17, produced by the RF signals with the amplitude spectra shown in FIG. 18.

### APPLICATION EXAMPLES

The modulator or RF-to-optical encoder device according to a preferred embodiment of the invention can be used as an ultrafast coherent detector for high-frequency radiation up to the THz range. The device operates at room temperature, and is capable of instantaneous encoding of incoming THz signal onto an optical signal transmitted through or reflected off the device (or probing the device). This optical signal is then analyzed/handled in a conventional manner, and it carries the information/features of the detected THz signal.

Compared to other coherent detection schemes, such as free-space electrooptic sampling (FEOS) and photoconductive sampling (PCS), the method and device according to the invention provides the advantage of being virtually independent of the mutual orientations of polarizartions of optical and THz signals, and of the the crystallographic axes of the semiconductor. Hence, the device according to the invcention is virtually polarization-insensitive.

Applications

The invention can advantageously be applied for many different applications, and the exact set-up applicable in each application will be within the capabilities of the person skilled in the art. Some of the envisioned applications are:
1) Tbit/s and sub-Tbit/s free-space RF serial communications. The digital data stream with the bit rate of sub-Tbit/s or several Tbit/s is transmitted as a series of RF signals, where each signal in the sequence represents a single bit of data. The invention will allow to detect/coherently encode the digital data serial stream carrier by a wireless signal onto an optical signal, that can be handled in a known way and the the data can thus be read out from this optical signal.
2) High frequency optical communication. Generally, any high frequency wireless RF signal with the frequencies up to THz range can be directly encoded onto an optical signal, which is then transmitted in a fibre-based network. The communication protocol can be both analog and digital.Thus, no intermediate signal conversion is needed.
3) THz spectroscopy and sensing. THz spectroscopic info is encoded onto the optical “probe” signal in the form of “side-bands” that can be easily converted into THz spectra and analyzed.
4) Military applications. Clandestine communications, detection of THz sources etc.
5) A general-purpose room-temperature detector of THz radiation. Based on the invention, general-purpose THz detectors can be easily manufactured, and does not need critical alignment of its internal components
6) THz signal phase-sensitive detector. By applying a pre-bias, one can detect not only the absolute value, but also the phase of incoming THz signal (but then it will be polarizarion-dependent). Here, the device can also be used to determine the polarization of incoming THz signal, see the embodiment described in relatin to FIG. 13c.
7) Synchronization of optical sources to THz sources. The proposed method can be used for instantaneous modulation of the loss in, for example, a semiconductor saturable absorber of a modelocked laser (solid state laser, gas laser, fiber laser, etc) by a THz input from a THz source such as, for example, a free-electron laser (FEL) or synchrotron (master sources). The effect will be thus used for synchronization (slaving) of a modelocked laser to a FEL or synchrotron, by “mode-pulling” of the modelocked laser. Therefore, the THz pulses from an FEL or a synchrotron will be time-synchronozed with the pulses of a modelocked laser, given the repetition rates of a THz master source, and a slave modelocked laser are close enough. Such a time-synchronization is important for many scientific experiments with FELs and synchrotrons.

In preferred embodiments, the invention provides a signal modulator adapted for any one or more of these applications, as well as the use of a a signal modulator according to the invention for the purpose of any one or more of these applications.

### REFERENCES

EP 1 416 316
GB 2 386 965
Kroll et al., “High-performance terahertz electro-optic detector”, Electron. Lett. vol. 40, pp. 763-764 (2004)
Fekete et al., “Active optical control of the terahertz reflectivity of high-resistivity semiconductors”, Opt. Lett. vol. 30, pp. 1992-1994 (2005)
Turchinovich et al., “Flexible all-plastic mirrors for the THz range”, Appl. Phys. A: Materials Science and Processing, vol. 74, pp. 291-293 (2002)
U.S. Pat. No. 6,954,309
Seo et al. “Terahertz field enhancement by a metallic nano slit operating beyond the skin-depth limit”, Nature Photonics, vol. 3, pp. 152-165 (2009).

1. A method for modulating an optical input signal having a first frequency, comprising:
coupling the optical input signal into a semiconductor nanostructure region in a semiconductor structure through a first optical interface, the semiconductor structure comprising:
the semiconductor nanostructure region, the semiconductor nanostructure region comprising a plurality of semiconductor nanostructure elements, the semiconductor nanostructure region being capable of absorbing a portion of the optical input signal coupled into the semiconductor nano structure region;
the first optical interface;
a second optical interface through which a non-absorbed portion of the optical input signal can be coupled out of the semiconductor nanostructure region in the form of a modulated optical output signal; and
a radio frequency receiver element facilitating a low-loss coupling of a wireless modulation radio frequency signal having a second frequency into the semiconductor nanostructure region;
providing the wireless modulation radio frequency signal to the radio frequency receiver element and coupling the wireless modulation radio frequency signal into the semiconductor nanostructure region in temporal overlap with the optical input signal to provide a time-dependent electric field across the semiconductor nanostructure regionresulting, by means of the quantum-confined Stark effect (QCSE), in a change in an absorption at the first frequency of the optical input signal in the semiconductor nanostructure region; and
coupling a non-absorbed portion of the optical input signal through the second optical interface, thereby providing said modulated optical output signal,
wherein the first frequency corresponds to a photon energy sufficient for exciting a charge carrier from a valence band state to a conduction band state so that the modulation of the optical input signal is substantially created by absorption.

2-14. (canceled)

15. The method in accordance with claim 1, wherein the low-loss coupling facilitated by the radio frequency receiver element is obtained by providing an antireflection coating or impedance matching layer or layers at the radio frequency receiver element.

16. The method in accordance with claim 1, wherein the modulation radio frequency signal is an output from a radio frequency spectroscopy process, radio frequency sensing process, or radio frequency imaging process.

17. The method in accordance with claim 1, wherein the second frequency is in the range 5 GHz to 50 THz.

18. The method in accordance with claim 1, wherein the second frequency is in the range 5 GHz to 20 THz.

19. The method in accordance with claim 1, wherein the optical input signal and the radio frequency modulation signal co-propagate in the semiconductor structure.

20. The method in accordance with claim 19, wherein a group velocity of the optical input signal in the semiconductor structure is identical or substantially identical to a group velocity of the radio frequency modulation signal.

21. A signal modulator for providing an optical output signal based on a wireless radio frequency modulation signal and an optical input signal, the optical output signal having a first frequency and the radio frequency modulation signal having a second frequency, the signal modulator comprising:
a semiconductor structure comprising:
a semiconductor nanostructure region comprising a plurality of semiconductor nanostructure elements, the semiconductor nanostructure region being capable of absorbing a portion of the input signal;
a first optical interface through which the optical input signal can be coupled into the semiconductor nanostructure region;
a second optical interface through which a non-absorbed portion of the optical input signal can be coupled out of the semiconductor nanostructure region to form the optical output signal; and
a radio frequency receiver element facilitating a low-loss coupling of a wireless modulation radio frequency signal having a second frequency into the semiconductor nanostructure region,
wherein the first frequency corresponds to a photon energy sufficient for exciting a charge carrier from a valence band state to a conduction band state so that the modulation of the optical input signal is substantially created by absorption.

22. The signal modulator in accordance with claim 21, wherein the low-loss coupling is obtained by providing only layers having a low doping level or doping levels between the semiconductor nanostructure region and the radio frequency receiver element.

23. The signal modulator in accordance with claim 21, wherein the low-loss coupling is obtained by providing an antireflection coating or impedance matching layer or layers at the radio frequency receiver element.

24. The signal modulator in accordance with claim 21, further comprising:
a radio frequency emitter for providing the wireless radio frequency modulation signal at the second frequency to the radio frequency receiver element of the signal modulator.

25. The signal modulator in accordance with claim 21, wherein the radio frequency emitter is one of: a photoconductive switch (Auston switch), a photo-excitable nonlinear crystal, a gas laser, a free-electron laser, a photomixer or a radio frequency mixer, a Gunn-diode, a Schottky diode, or a quantum-cascade laser.

26. An interferometer-based optical encoder for encoding an optical input signal with a wireless radio frequency modulation signal, comprising:
a first interferometer arm comprising a signal modulator in accordance with claim 21;
a second interferometer arm comprising an optical phase shifter coupled to an optical attenuator or optical amplifier, the phase shifter allowing an adjustment of a phase of an optical signal in the phase shifter, the attenuator or amplifier allowing an adjustment of the amplitude of an optical signal in the attenuator or amplifier;
an input port and splitter for splitting the input signal into a first signal part and a second signal part for coupling into the first arm and second arm, respectively; and
an optical output port for combining an output from the first arm and an output from the second arm.
